(19) United States
(12) Patent Application Publication
(10) Pub. No.: US 2026/0260884 A1
(43) Pub. Date: Sep. 3, 2026

(54) Precursor for Positive Electrode Active Material, Positive Electrode Active Material, Method of Manufacturing Precursor for Positive Electrode Active Material, Positive Electrode, and Lithium Secondary Battery

(71) Applicant: LG Energy Solution, Ltd., Seoul (KR)

(72) Inventors: Si Yeol Lee, Daejeon (KR); Jong Wook Heo, Daejeon (KR); So Yeong Yun, Daejeon (KR); Ye Jin Kim, Daejeon (KR)

(73) Assignee: LG Energy Solution, Ltd., Seoul (KR)

(21) Appl. No.: 19/552,106

(22) Filed: Feb. 27, 2026

(30) Foreign Application Priority Data
Feb. 28, 2025 (KR) 10-2025-0027118

(51) Int. Cl. H01M 4/525; C01G 53/504; C01G 53/84; H01M 4/02; H01M 10/0525

(52) U.S. Cl. CPC H01M 4/525; C01G 53/504; C01G 53/84; H01M 10/0525; C01P 2002/60; C01P 2002/74; C01P 2004/61; C01P 2006/40; H01M 2004/021

(57) ABSTRACT

A precursor for a positive electrode active material includes a nickel-based hydroxide containing nickel in an amount of about 60 mol % or more, based on the total metal content, and having a ratio of a (101) crystallite size (unit: nm) to a Ni content (unit: mol %) of about 1.5 nm/mol % to 2.0 nm/mol %, based on the total metal content.

### CROSS-REFERENCE TO RELATED APPLICATIONS

This application is based on and claims priority from Korean Patent Application No. 10-2025-0027118 filed on Feb. 28, 2025, with the Ministry of Intellectual Property, the disclosure of which is incorporated herein in its entirety by reference.

### TECHNICAL FIELD

The present disclosure relates to a precursor for a positive electrode active material, a positive electrode active material, a method of manufacturing the precursor for a positive electrode active material, a positive electrode, and a lithium secondary battery.

### BACKGROUND

Lithium-ion secondary batteries are widely used in various fields, such as portable electronic devices, electric vehicles, and energy storage systems (ESS), due to their high energy density and excellent cycle characteristics. In order to improve the performance of such lithium-ion secondary batteries, various compositions have been studied as positive electrode active materials. For example, high-nickel positive electrode active materials having a high nickel (Ni) content are attracting attention as next-generation positive electrode materials due to their ability to achieve high capacity and high energy density.

However, high-nickel positive electrode active materials still require further improvement in terms of structural and chemical stability.

### SUMMARY

The present disclosure provides a precursor for a positive electrode active material, a positive electrode active material, a method of preparing the precursor for a positive electrode active material, a positive electrode, and a lithium secondary battery, which exhibit excellent capacity characteristics while reducing electrolyte side reactions, thereby improving resistance characteristics and cycle life characteristics.

[1] The present disclosure relates to a precursor for a positive electrode active material, the precursor including a nickel-based hydroxide containing nickel in an amount of about 60 mol % or more, based on the total metal content, and having a ratio of a (101) crystallite size (unit: nm) to a Ni content (unit: mol %) of about 1.5 nm/mol % to 2.0 nm/mol %, based on the total metal content.

[2] The present disclosure provides the precursor for a positive electrode active material as set forth in [1], in which the nickel-based hydroxide is represented by Formula 1:

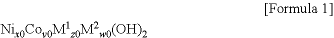

In Formula 1, 0.60≤x0<1.0, 0<y0≤0.3, 0<z0≤0.3, and 0≤w0≤0.1, M¹ is Mn, Al, or a combination thereof, and M² is one or more doping elements selected from W, Cu, Fe, V, Cr, Ti, Zr, Zn, In, Ta, Y, Sr, Ga, Sc, Ca, Nb, Mg, B, and Mo.

[3] The present disclosure provides the precursor for a positive electrode active material as set forth in [1] or [2], in which an average particle diameter D₅₀ is about 10.0 μm to 15.0 μm.

[4] The present disclosure provides the precursor for a positive electrode active material as set forth in at least one of [1] to [3], in which the nickel content based on the total metal content is about 70 mol % to 80 mol %.

[5] The present disclosure provides the precursor for a positive electrode active material as set forth in at least one of [1] to [4], in which the (101) crystallite size is about 100 nm to 200 nm.

[6] The present disclosure provides the precursor for a positive electrode active material as set forth in at least one of [1] to [5], in which an I(001)/I(100) value measured by XRD is about 3.0 to 4.0.

[7] The present disclosure provides a positive electrode active material including a lithium nickel-based oxide containing nickel in an amount of about 60 mol % or more based on the total metal content excluding lithium, and having a ratio of an average crystallite size (unit: nm) to a Ni content (unit: mol %) of about 1.9 nm/mol % to 3.0 nm/mol %, based on the total metal content excluding lithium.

[8] The present disclosure provides the positive electrode active material as set forth in [7], in which the positive electrode active material includes secondary particles.

[9] The present disclosure provides the positive electrode active material as set forth in [7] or [8], in which the positive electrode active material has an average particle diameter D₅₀ of about 10.0 μm to 15.0 μm.

The present disclosure provides the positive electrode active material as set forth in at least one of [7] to [9], in which the average crystallite size is about 500 nm to 800 nm.

The present disclosure provides the positive electrode active material as set forth in at least one of [7] to [10], in which an I(003)/I(104) value measured by XRD is about 1.0 to 2.0.

The present disclosure provides a positive electrode including the positive electrode active material according to any one of [7] to [11].

The present disclosure provides a lithium secondary battery including the positive electrode according to [12], a negative electrode disposed to face the positive electrode, and an electrolyte.

The present disclosure provides a method of preparing a positive electrode active material, the method including mixing a precursor for a positive electrode active material including a nickel-based hydroxide containing nickel in an amount of about 60 mol % or more based on the total metal content with a lithium raw material, and calcining the mixture to prepare a positive electrode active material, in which the precursor for a positive electrode active material has a ratio of a (101) crystallite size (unit: nm) to a Ni content (unit: mol %) of about 1.5 nm/mol % to 2.0 nm/mol %, based on the total metal content.

The present disclosure provides the method of preparing the positive electrode active material as set forth in [14], in which the calcining is performed at a temperature of about 600° C. to 900° C.

The present disclosure provides the method of preparing the positive electrode active material as set forth in [14], in which the precursor for a positive electrode active material is prepared through: step (1) forming nuclei of the precursor for a positive electrode active material by co-precipitating a transition metal aqueous solution, an ammonium cation complexing agent, and a basic compound to form a reaction solution; and step (2) growing particles of the precursor for a positive electrode active material by co-precipitating while supplying a transition metal aqueous solution, an ammonium cation complexing agent, and a basic compound to the reaction solution in which the nuclei of the precursor for a positive electrode active material have been formed.

The present disclosure provides the method of preparing the positive electrode active material as set forth in [16], in which step (1) is performed in a first reactor, and step (2) is performed after transferring the reaction solution in which the nuclei of the precursor for a positive electrode active material have been formed, from the first reactor to a second reactor.

The precursor for a positive electrode active material according to the present disclosure includes a nickel-based hydroxide containing nickel in an amount of about 60 mol % or more based on the total metal content, and the ratio of the (101) crystallite size (unit: nm) to the Ni content (unit: mol %) based on the total metal content satisfies a specific range. According to the present disclosure, high capacity may be achieved by allowing the nickel-based hydroxide to contain nickel in an amount of about 60 mol % or more based on the total metal content. In the present disclosure, by designing the (101) crystallite size in the precursor for a positive electrode active material before calcination to fall within an optimal range according to the nickel content, the average crystallite size of the positive electrode active material relative to the nickel content may be controlled within a range that ensures structural stability and lithium ion diffusion even without increasing the calcination temperature. Accordingly, formation of a surface rock-salt phase may be suppressed, and structural stability of the positive electrode active material may be improved.

In addition, the positive electrode active material according to the present disclosure contains nickel in an amount of about 60 mol % or more based on the total metal content excluding lithium, and the ratio of the average crystallite size to the nickel content based on the total metal content excluding lithium satisfies a specific range. Accordingly, formation of a surface rock-salt phase may be suppressed, and excellent crystallinity may be achieved, so that excellent structural stability and lithium ion diffusivity of the positive electrode active material may be exhibited.

By including the positive electrode active material according to the present disclosure, the positive electrode and the lithium secondary battery according to the present disclosure may exhibit excellent capacity characteristics and excellent high-temperature cycle life characteristics, and may also suppress resistance increase of the battery.

### BRIEF DESCRIPTION OF THE DRAWINGS

The following drawings attached hereto illustrate embodiments of the present disclosure and serve to further understand the technical idea of the present disclosure together with the detailed description of the disclosure to be described later. Therefore, the present disclosure should not be construed as being limited to the matters illustrated in the drawings.

FIG. 1 is a flowchart illustrating a method of manufacturing a positive electrode active material, according to an embodiment of the present disclosure.

FIG. 2 is a flowchart illustrating a method of manufacturing a precursor for a positive electrode active material, according to an embodiment of the present disclosure.

In the accompanying drawings, elements of well-known technology that are useful or essential in commercially feasible embodiments may often be omitted so as not to obscure the spirit of various embodiments of the present disclosure.

### DETAILED DESCRIPTION

The terms or words used in the specification and claims should not be construed as limited to their ordinary or dictionary meanings, but should be construed as having meanings and concepts consistent with the technical concept of the present disclosure based on the principle that an inventor may appropriately define the concepts of terms in order to explain the inventor's own invention in the best manner.

The terms used herein are used only for the purpose of describing illustrative embodiments and are not intended to limit the present disclosure. As used herein, singular forms include plural forms unless the context clearly indicates otherwise.

As used herein, terms such as “include,” “comprise,” or “have” are intended to specify the presence of stated features, numbers, steps, components, or combinations thereof, but are to be understood as not precluding the possibility of the presence or addition of one or more other features, numbers, steps, components, or combinations thereof.

In the present disclosure, the term “single-particle-type particle” refers to a particle made up of 30 or fewer sub-particles. The sub-particle unit constituting the single-particle-type particle will be referred to as a “nodule.” The single-particle-type particle includes a single particle made up of one single nodule and a quasi-single particle that is a composite of 30 or fewer nodules.

The term “nodule” refers to a sub-particle unit body constituting the single particle and the quasi-single particle. The nodule may be a single crystal lacking a crystalline grain boundary, or a polycrystal that appears to have no visible grain boundary when observed at a magnification of 5,000 to 20,000x using a scanning electron microscope (SEM).

In the present disclosure, the term “secondary particle” refers to a particle formed by aggregation of more than 30 sub-particles. In order to distinguish from the sub-particles constituting the single-particle-type particle, each lower particle unit constituting the secondary particle is referred to as a “primary particle.”

As used in the present disclosure, the term “particle” may include any one or all of a single particle, a quasi-single particle, a primary particle, a nodule, and a secondary particle.

In the present disclosure, “average particle diameter D₅₀” refers to a particle size corresponding to 50% of the cumulative volume in the volume-based particle size distribution of a powder to be measured, and may be measured using a laser diffraction method. For example, the powder to be measured may be dispersed in a dispersion medium and introduced into a commercially available laser diffraction particle size analyzer (e.g., Microtrac MT 3000). After irradiating the powder dispersed in the dispersion medium with ultrasonic waves at about 28 kHz with an output of 60 W, a volume-based particle size distribution graph may be obtained, and the particle size corresponding to 50% of the cumulative volume may be determined therefrom.

In the present disclosure, the term “crystallite” refers to a distinct region in which atoms form a lattice structure in a certain orientation, and means a particle unit having substantially the same crystallographic orientation.

In the present disclosure, “average crystallite size” refers to an overall average value of all crystallite sizes measured by X-ray diffraction (XRD), and may be determined using XRD data through the Rietveld method. For example, the “average crystallite size” may be obtained by placing a sample in a recessed groove at the center of a general powder holder, leveling the surface of the sample using a slide glass while adjusting the height to be flush with the edge of the holder, acquiring XRD data using an X-ray diffractometer (Bruker, D8 Endeavor) under the following conditions: radiation source: Cu Kα, λ=1.54 Å, λθ=10° to 80°, step size=0.02°, total scan time: 120 min, and analyzing the XRD data using the Fundamental Parameter Approach embedded in the TOPAS program (Bruker) based on the Rietveld method to determine the average crystallite size.

In the present disclosure, “(101) crystallite size” refers to an average value of the (101) crystallite sizes measured by X-ray diffraction (XRD), and may be determined through the Rietveld method using XRD data. For example, the “(101) crystallite size” may be obtained by placing a sample in a recessed groove at the center of a general powder holder, leveling the surface of the sample using a slide glass while adjusting the height to be flush with the edge of the holder, acquiring XRD data using an X-ray diffractometer (Bruker, D₈ Endeavor) under the following conditions: radiation source: Cu Kα, λ=1.54 Å, 2θ=10° to 80°, step size=0.02°, total scan time: 120 min, and analyzing the XRD data using the Fundamental Parameter Approach embedded in the TOPAS program (Bruker) based on the Rietveld method to determine the (101) crystallite size.

In the present disclosure, the “I(001)/I(100) value” refers to a ratio of the peak intensity I(001) of the (001) plane to the peak intensity I(100) of the (100) plane, obtained by performing X-ray diffraction (XRD) analysis on a material to be measured. For example, the “I(001)/I(100) value” may be measured by fixing a sample to be measured on a holder, obtaining XRD data using an X-ray diffractometer (Bruker, D8 Endeavor) under the following conditions: radiation source: Cu Kα, λ=1.54 Å, 2θ=10° to 80°, step size=0.02°, total scan time: 120 min, and fitting all peaks within the measurement range using the FP (First Principle) peak type available in TOPAS while applying only the Lorentzian contribution. In this case, strain is not considered.

In the present disclosure, the “I(003)/I(104) value” refers to a ratio of the peak intensity I(003) of the (003) plane to the peak intensity I(104) of the (104) plane, obtained by performing X-ray diffraction (XRD) analysis on a material to be measured. For example, the “I(003)/I(104) value” may be measured by fixing a sample to be measured on a holder, obtaining XRD data using an X-ray diffractometer (Bruker, D8 Endeavor) under the following conditions: radiation source: Cu Kα, λ=1.54 Å, 2θ=10° to 80°, step size=0.02°, total scan time: 120 min, and fitting all peaks within the measurement range using the FP (First Principle) peak type available in TOPAS while applying only the Lorentzian contribution. In this case, strain is not considered.

As the demand for improved capacity characteristics of secondary batteries has recently increased, attempts have been made to increase the nickel content contained in positive electrode active materials. However, although the capacity increases as the nickel content in the positive electrode active material increases, structural instability is caused by cation mixing between nickel and lithium or structural transition at high voltage.

In addition, side reactivity with the electrolyte is accelerated, and by-products generated at the interface between the electrode and the electrolyte cause an increase in interfacial resistance. As a result, the resistance characteristics of the battery deteriorate, and cycle life characteristics during long-term charge and discharge cycles are reduced. Accordingly, there is a need for developing a positive electrode active material that exhibits excellent capacity characteristics while being capable of improving the structural stability and reducing the side reactions with the electrolyte.

In view of the foregoing, the present disclosure provides a configuration capable of securing stability of the internal structure itself of a positive electrode active material. For example, since the degree of structural instability varies depending on the nickel content, the present disclosure provides a configuration for optimizing the internal structure of the positive electrode active material according to the nickel content. In addition, the crystallite size of the positive electrode active material is closely related to the degree of formation of grain boundaries, at which structural defects are likely to occur, and may affect, for example, the degree of internal cracking within crystals. Accordingly, the crystallite size acts as a factor determining the structural stability of the positive electrode active material.

Therefore, by optimizing the crystallite size according to the nickel content in the positive electrode active material, the present disclosure may secure structural stability of the positive electrode active material even when the nickel content is increased, thereby improving high-temperature cycle life characteristics and resistance characteristics.

In addition, the present disclosure may provide the above-described positive electrode active material by controlling physical properties of a precursor for the positive electrode active material itself.

A precursor for a positive electrode active material, a positive electrode active material, a positive electrode, a lithium secondary battery, and/or a method of manufacturing the precursor for a positive electrode active material, according to the present disclosure, may include at least one of the configurations disclosed below, and may include any combination among the configurations that are technically feasible.

### Precursor for Positive Electrode Active Material

A precursor for a positive electrode active material, according to the present disclosure, includes a nickel-based hydroxide containing nickel in an amount of about 60 mol % or more based on the total metal content. For example, the precursor for a positive electrode active material may include a nickel-based hydroxide containing nickel in an amount of about 60 mol % or more, 65 mol % or more, 70 mol % or more, less than 100 mol %, 95 mol % or less, 90 mol % or less, 85 mol % or less, 80 mol % or less, 75 mol % or less, 72 mol % or less, or 70 mol % or less, based on the total metal content. Alternatively, the precursor for a positive electrode active material may include a nickel-based hydroxide containing nickel in an amount of about 60 mol % or more, 65 mol % or more, 70 mol % or more, 70 mol % to 90 mol %, 70 mol % to 80 mol %, or 70 mol % to 75 mol %, based on the total metal content. When the above range is satisfied, a positive electrode active material having high energy density may be prepared, and thus the capacity characteristics of the battery may be excellent.

The nickel-based hydroxide may be represented by Formula 1:

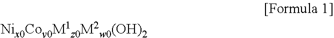

In Formula 1, M¹ may be Mn, Al, or a combination thereof. When M¹ is included, the structural stability of the nickel-based hydroxide may be improved.

In Formula 1, M² may be one or more doping elements selected from W, Cu, Fe, V, Cr, Ti, Zr, Zn, In, Ta, Y, Sr, Ga, Sc, Ca, Nb, Mg, B, and Mo, or one or more doping elements selected from W, Y, Ba, Ca, Ti, Mg, Ta, and Nb. M² may be optionally included in the nickel-based hydroxide represented by Formula 1 or may not be included. When included, M² may facilitate calcination or improve structural stability.

In Formula 1, x0 refers to a molar ratio of nickel based on the total metal content in the nickel-based hydroxide particle, and may satisfy 0.60≤x0<1.0, 0.65≤x0<1.0, 0.70≤x0<1.0, 0.70≤x0≤0.90,0.70≤x0≤0.80, or 0.70≤x0≤0.75. When the above range is satisfied, the positive electrode active material prepared therefrom may exhibit excellent capacity characteristics while securing structural stability.

In Formula 1, y0 refers to a molar ratio of cobalt based on the total metal content in the nickel-based hydroxide particle, and may satisfy 0<y0≤0.3, 0<y0≤0.2,0<y0≤0.15, or 0<y0≤0.1. When the above range is satisfied, cost advantages may be obtained while output characteristics may be improved.

In Formula 1, z0 refers to a molar ratio of M¹ based on the total metal content in the nickel-based hydroxide particle, and may satisfy 0<z0≤0.3, 0<z0≤0.25, or 0<z0≤0.2. When the above range is satisfied, the structural stability of a positive electrode active material prepared using the precursor for a positive electrode active material represented by Formula 1 may be improved.

In Formula 1, w0 refers to a molar ratio of M² based on the total metal content in the nickel-based hydroxide particle, and may satisfy 0≤w0≤0.1, 0≤w0≤0.08,0≤ w0≤0.05, or 0≤w0≤0.01. When the above range is satisfied, the positive electrode active material prepared using the precursor for a positive electrode active material represented by Formula 1 may promote particle growth during calcination or improve structural stability.

The precursor for a positive electrode active material may include a nickel-based hydroxide containing nickel, cobalt, and manganese. For example, the precursor for a positive electrode active material may include a nickel-based hydroxide represented by Formula 1-1 below. When the nickel-based hydroxide includes manganese, manganese may contribute to maintaining a layered structure of the nickel-based hydroxide, thereby improving structural stability.

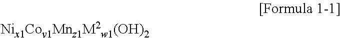

In Formula 1-1, M² may be one or more doping elements selected from Al, W, Cu, Fe, V, Cr, Ti, Zr, Zn, In, Ta, Y, Sr, Ga, Sc, Ca, Nb, Mg, B, and Mo, or one or more doping elements selected from Al, W, Y, Ba, Ca, Ti, Mg, Ta, and Nb. M² may be optionally included in the nickel-based hydroxide represented by Formula 1-1 or may not be included. When included, M² may facilitate calcination or improve structural stability.

In Formula 1-1, x1 refers to a molar ratio of nickel based on the total metal content in the nickel-based hydroxide particle, and may satisfy 0.60≤x1<1.0, 0.65≤x1<1.0, 0.70≤x1<1.0, 0.70≤x1≤0.90, 0.70≤x1≤0.80, or 0.70≤x1≤0.75. When the above range is satisfied, the positive electrode active material prepared using the nickel-based hydroxide represented by Formula 1-1 may exhibit excellent capacity characteristics.

In Formula 1-1, y1 refers to a molar ratio of cobalt based on the total metal content in the nickel-based hydroxide particle, and may satisfy 0<y1≤0.3,0<y1≤0.2, 0<y1≤0.15, or 0<y1≤0.1. When the above range is satisfied, cost advantages may be obtained while output characteristics may be improved.

In Formula 1-1, z1 refers to a molar ratio of manganese based on the total metal content in the nickel-based hydroxide particle, and may satisfy 0<z1≤0.3, 0<z1≤0.25, or 0<z1≤0.2. When the above range is satisfied, the structural stability of the positive electrode active material prepared using the nickel-based hydroxide represented by Formula 1-1 may be improved.

In Formula 1-1, w1 refers to a molar ratio of M² based on the total metal content in the nickel-based hydroxide particle, and may satisfy 0≤w1≤0.1, 0≤w1≤0.08,0≤ w1≤0.05, or 0≤w1≤0.01. When the above range is satisfied, the structural stability of the positive electrode active material prepared using the nickel-based hydroxide represented by Formula 1-1 may be improved.

The precursor for a positive electrode active material has a ratio of a (101) crystallite size (unit: nm) to a Ni content (unit: mol %) in a range of about 1.5 nm/mol % to 2.0 nm/mol %, based on the total metal content.

The present disclosure provides a positive electrode active material in which the average crystallite size is optimized according to the nickel content, thereby achieving excellent structural stability and improving high-temperature cycle life characteristics and resistance characteristics. In manufacturing a high-nickel positive electrode active material, the present disclosure may precisely control a calcination temperature in order to suppress formation of a surface rock-salt phase due to oxygen release and an increase in Ni²⁺ ions. For example, by maintaining a relatively low calcination temperature condition, chemical degradation may be suppressed while optimizing physical properties of the precursor for a positive electrode active material itself to induce smooth growth of crystallites.

The present disclosure enables preparation of a positive electrode active material having an optimal average crystallite size depending on a nickel content even at a relatively low calcination temperature by controlling characteristics of the precursor for a positive electrode active material itself rather than the calcination temperature.

For example, according to an embodiment of the present disclosure, the precursor for a positive electrode active material may satisfy a specific range of a (101) crystallite size depending on the nickel content. In the precursor for a positive electrode active material, the (101) plane corresponds to a (104) plane in the positive electrode active material. In the positive electrode active material, the (104) plane corresponds to a plane in which a lithium layer and a metal layer are projected in a mixed manner, represents an arrangement state of a transition metal sublattice structure, and may reflect crystallinity of the positive electrode active material. Among major crystal planes of the positive electrode active material, the (104) plane is associated with formation of long-range order in the transition metal sublattice and grows in a diffusion-controlled manner. Therefore, the growth of the (104) plane may be relatively more restricted at a relatively low calcination temperature. Accordingly, during calcination at a relatively low temperature, the (101) crystallite size of the precursor for a positive electrode active material may have a greater influence on controlling the average crystallite size according to the nickel content of the positive electrode active material.

Accordingly, the present disclosure designs the precursor for a positive electrode active material such that the ratio of a (101) crystallite size according to a nickel content satisfies the above range. Therefore, a positive electrode active material in which an average crystallite size according to the nickel content satisfies a specific range may be prepared even without increasing the calcination temperature, and a positive electrode active material having excellent crystallinity and thus excellent structural stability may be prepared. As a result, the resistance characteristics and the high-temperature cycle life characteristics of a battery may be excellent.

For example, the ratio of a (101) crystallite size (unit: nm) to a Ni content (unit: mol %) based on the total metal content may be about 1.5 nm/mol % or more, 1.55 nm/mol % or more, 1.6 nm/mol % or more, 1.65 nm/mol % or more, 1.7 nm/mol % or more, 1.75 nm/mol % or more, 1.8 nm/mol % or more, 2.0 nm/mol % or less, 1.97 nm/mol % or less, 1.95 nm/mol % or less, 1.91 nm/mol % or less, 1.9 nm/mol % or less, 1.85 nm/mol % or less, or 1.8 nm/mol % or less. Alternatively, the precursor for a positive electrode active material may have a ratio of a (101) crystallite size (unit: nm) to a Ni content (unit: mol %) based on the total metal content of about 1.5 nm/mol % to 2.0 nm/mol %, 1.6 nm/mol % to 1.97 nm/mol %, 1.7 nm/mol % to 1.95 nm/mol %, or 1.8 nm/mol % to 1.91 nm/mol %.

When the (101) crystallite size relative to the nickel content in the precursor for a positive electrode active material is excessively large, a crystal structure may collapse, and a rock-salt phase may be formed. Alternatively, when the (101) crystallite size is excessively small relative to the nickel content in the precursor for a positive electrode active material, sufficient crystallinity may not be secured in the positive electrode active material to be prepared, which may cause problems such as a decrease in capacity expression, deterioration of structural stability, and deterioration of resistance characteristics. Therefore, when the (101) crystallite size compared to the nickel content in the precursor for a positive electrode active material satisfies the above range, formation of a surface rock-salt phase may be suppressed, and crystallinity may be excellent. In addition, when preparing a positive electrode active material including nickel in a high content (e.g., about 60 mol % or more, 65 mol % or more, or 70 mol % to 80 mol %), positive electrode active material having an optimal average crystallite size according to the nickel content may be easily prepared even without increasing the calcination temperature due to, for example, a rock-salt phase formation and an oxygen release. Accordingly, the positive electrode active material may have an excellent structural and electrochemical stability and an excellent resistance characteristics, and the battery may have excellent capacity characteristics, high-temperature cycle life characteristics, and output characteristics.

The Ni content based on the total metal content may be about 60 mol % or more, 65 mol % or more, 70 mol % or more, 70 mol % to 90 mol %, 70 mol % to 80 mol %, or 70 mol % to 75 mol %. When the above range is satisfied, the prepared positive electrode active material may have an excellent energy density, and the structural stability may be secured.

The (101) crystallite size may be about 100 nm to 200 nm, 110 nm to 140 nm, or 120 nm to 130 nm. When the above range is satisfied, the crystal structure of the prepared positive electrode active material may be further stabilized, and high-capacity characteristics may be achieved.

The precursor for a positive electrode active material may have an I(001)/I(100) value measured by XRD, of about 3.0 to 4.0, 3.2 to 3.90, 3.35 to 3.80, 3.36 to 3.70, 3.37 to 3.60, 3.38 to 3.50, or 3.39 to 3.45. When the above range is satisfied, the crystal orientation of the precursor for a positive electrode active material may be secured to a certain level or higher, and the structural stability may be excellent. Accordingly, the crystallinity of the prepared positive electrode active material may be controlled, a layered structure may be well formed, and cation mixing between lithium ions and nickel ions may be reduced, thereby improving structural stability of the positive electrode active material, reducing resistance, and providing excellent cycle life characteristics.

The precursor for a positive electrode active material may have an average particle diameter D₅₀ of about 10.0 μm to 15.0 μm, 11.0 μm to 14.0 μm, 11.5 μm to 13.5 μm, or 12.0 μm to 13.0 μm. When the above range is satisfied, the size of the prepared positive electrode active material may be appropriate, and the particle breakage during electrode rolling may be reduced. Accordingly, an occurrence of cracks in the electrode may be suppressed, thereby suppressing an increase in resistance or deterioration of cycle life characteristics.

### Positive Electrode Active Material

The positive electrode active material, according to the present disclosure, includes a lithium nickel-based oxide containing nickel in an amount of about 60 mol % or more based on the total metal content excluding lithium. For example, the positive electrode active material, according to the present disclosure, may include a lithium nickel-based oxide containing nickel in an amount of about 60 mol % or more, 65 mol % or more, 70 mol % or more, 70 mol % to 90 mol %, 70 mol % to 80 mol %, or 70 mol % to 75 mol %, based on the total metal content excluding lithium. In this case, the positive electrode active material may have an excellent energy density and excellent capacity characteristics.

The lithium nickel-based oxide may be represented by Formula 2:

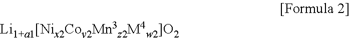

In Formula 2, M³ may be Mn, Al, or a combination thereof. When M³ is included, the structural stability of the lithium nickel-based oxide may be improved.

In Formula 2, M⁴ may be one or more doping elements selected from W, Cu, Fe, V, Cr, Ti, Zr, Zn, In, Ta, Y, Sr, Ga, Sc, Ca, Nb, Mg, B, and Mo, or one or more doping elements selected from W, Y, Ba, Ca, Ti, Mg, Ta, and Nb. M⁴ may be optionally included in the lithium nickel-based oxide represented by Formula 2 or may not be included. When included, M⁴ may facilitate calcination or improve structural stability.

In Formula 2, 1+a1 may represent a molar ratio of lithium (Li) in the lithium nickel-based oxide, and may satisfy 0.5≤1+a1≤1.5, 0.8≤1+a1≤1.5, 1.0≤1+a1≤1.5, 1.0≤1+a1≤1.2, 1.0≤1+a1≤1.1, or 1.0≤1+a1≤1.05. When the above range is satisfied, the positive electrode active material may form a stable layered crystal structure.

In Formula 2, x2 refers to a molar ratio of nickel based on the total metal content excluding lithium in the lithium nickel-based oxide particle, and may satisfy 0.60≤x2<1.0, 0.65≤x2<1.0, 0.70≤x2<1.0,0.70≤x2≤0.90,0.70≤x2≤0.80, or 0.70≤×2≤ 0.75. When the above range is satisfied, the positive electrode active material may exhibit excellent capacity characteristics.

In Formula 2, y2 refers to a molar ratio of cobalt based on the total metal content excluding lithium in the lithium nickel-based oxide particle, and may satisfy 0<y2≤0.3, 0<y2≤0.2, 0<y2≤0.15, or 0<y2≤0.1. When the above range is satisfied, cost advantages may be obtained while output characteristics may be improved.

In Formula 2, z2 refers to a molar ratio of M³ based on the total metal content excluding lithium in the lithium nickel-based oxide particle, and may satisfy 0<z2≤0.3, 0<z2≤0.25, or 0<z2≤0.2. When the above range is satisfied, the structural stability of the positive electrode active material may be improved.

In Formula 2, w2 refers to a molar ratio of M⁴ based on the total metal content excluding lithium in the lithium nickel-based oxide particle, and may satisfy 0≤w2≤ 0.1, 0≤w2≤0.08, 0≤w2≤0.05, or 0≤w2≤0.01. When the above range is satisfied, particle growth during calcination of the positive electrode active material may be promoted, or crystal structure stability may be improved.

The positive electrode active material may include a lithium nickel-based oxide containing nickel, cobalt, and manganese. For example, the positive electrode active material may include a lithium nickel-based oxide represented by Formula 2-1 below. When the lithium nickel-based oxide includes manganese, manganese may contribute to maintaining a layered structure of the lithium nickel-based oxide, and, as a result, the structural stability may be improved.

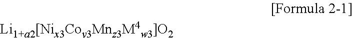

In Formula 2-1, M⁴ may be one or more doping elements selected from Al, W, Cu, Fe, V, Cr, Ti, Zr, Zn, In, Ta, Y, Sr, Ga, Sc, Ca, Nb, Mg, B, and Mo, or one or more doping elements selected from Al, W, Y, Ba, Ca, Ti, Mg, Ta, and Nb. M⁴ may be optionally included in the lithium nickel-based oxide represented by Formula 2-1 or may not be included. When included, M⁴ may facilitate calcination or improve structural stability.

In Formula 2-1, 1+a2 may represent a molar ratio of lithium (Li) in the lithium nickel-based oxide, and may satisfy 0.5≤1+a2≤1.5, 1.0≤1+a2≤1.5, 1.0≤1+a2≤1.2, 1.0≤1+a2≤1.1, or 1.0≤1+a2≤1.05. When the above range is satisfied, the positive electrode active material may form a stable layered crystal structure.

In Formula 2-1, x3 refers to a molar ratio of nickel based on the total metal content excluding lithium in the lithium nickel-based oxide particle, and may satisfy 0.60≤x3<1.0, 0.65≤x3<1.0, 0.70≤x3<1.0, 0.70≤x3≤0.90,0.70≤x3≤0.80, or 0.70≤ x3≤0.75. When the above range is satisfied, the positive electrode active material may exhibit excellent capacity characteristics.

In Formula 2-1, y3 refers to a molar ratio of cobalt based on the total metal content excluding lithium in the lithium nickel-based oxide particle, and may satisfy 0<y3≤0.3, 0<y3≤0.2,0<y3<0.15, or0<y3≤0.1. When the above range is satisfied, cost advantages may be obtained while output characteristics may be improved.

In Formula 2-1, z3 refers to a molar ratio of manganese based on the total metal content excluding lithium in the lithium nickel-based oxide particle, and may satisfy 0<z3≤0.3, 0<z3<0.25, or 0<z3≤0.2. When the above range is satisfied, the structural stability of the positive electrode active material may be improved.

In Formula 2-1, w3 refers to a molar ratio of M⁴ based on the total metal content excluding lithium in the lithium nickel-based oxide particle, and may satisfy 0≤w3≤ 0.1, 0≤w3≤0.08, 0≤w3≤0.05, or 0≤w3≤0.01. When the above range is satisfied, the structural stability of the positive electrode active material may be improved.

The positive electrode active material, according to the present disclosure, has a ratio of an average crystallite size (unit: nm) to a Ni content (unit: mol %) based on the total metal content excluding lithium, in a range of about 1.9 nm/mol % to 3.0 nm/mol %.

As the nickel content in the positive electrode active material increases, the structural stability of the positive electrode active material may be deteriorated. For example, such structural instability may be mainly caused by cation mixing between nickel and lithium due to the increased nickel content, or structural transition at high voltage. Since the nickel content affects the internal structure of the positive electrode active material, in order to improve the structural stability in a positive electrode active material containing nickel in a high content, it may be necessary to optimally design the internal structure of the positive electrode active material according to the nickel content thereof.

In the positive electrode active material, crystallite size is one of the factors determining the degree of formation of grain boundaries, and since the grain boundaries contain many structural defects, are prone to cation mixing, and readily become initiation sites for oxygen release and crack formation, the grain boundaries may affect structural stability of the positive electrode active material. In addition, depending on the crystallite size of the positive electrode active material, the degree of stress relaxation during charge and discharge may vary, and the lithium ion diffusivity may be affected.

Accordingly, by optimally designing an average crystallite size according to the nickel content as an internal structure of the positive electrode active material, the structural stability of the positive electrode active material may be improved, and the resistance characteristics may be improved.

For example, the ratio of an average crystallite size (unit: nm) to a Ni content (unit: mol %) based on the total metal content excluding lithium may be about 1.9 nm/mol % or more, 2.0 nm/mol % or more, 2.1 nm/mol % or more, 2.2 nm/mol % or more, 2.3 nm/mol % or more, 2.4 nm/mol % or more, 2.5 nm/mol % or more, 2.6 nm/mol % or more, 2.7 nm/mol % or more, 2.8 nm/mol % or more, 2.9 nm/mol % or more, 3.0 nm/mol % or less, 2.99 nm/mol % or less, 2.98 nm/mol % or less, or 2.97 nm/mol % or less. Alternatively, the positive electrode active material may have a ratio of an average crystallite size (unit: nm) to a Ni content (unit: mol %) based on the total metal content excluding lithium, in a range of about 1.9 nm/mol % to 3.0 nm/mol %, 2.5 nm/mol % to 2.99 nm/mol %, or 2.9 nm/mol % to 2.98 nm/mol %. When the average crystallite size is excessively large relative to the nickel content in the positive electrode active material, cracks may occur inside the crystallites during charge and discharge, which may cause problems such as structural collapse and formation of a rock-salt phase, and, as a result, the resistance may increase. In addition, when the average crystallite size is excessively small relative to the nickel content in the positive electrode active material, the crystallinity of the positive electrode active material may be low, which may cause problems such as deterioration of capacity expression and structural stability.

Accordingly, when the above range is satisfied, the positive electrode active material may have an excellent crystallinity, excellent lithium ion diffusivity, and excellent resistance characteristics, capacity characteristics, and structural stability. Accordingly, the prepared lithium secondary battery may exhibit excellent output characteristics, excellent cycle life characteristics, and excellent capacity. In a positive electrode active material in which a nickel content based on the total metal content excluding lithium is about 60 mol % or more, 65 mol % or more, or 70 mol % to 80 mol %, the structural instability caused by nickel may be further intensified. Accordingly, when the ratio of an average crystallite size (unit: nm) to a Ni content (unit: mol %) based on the total metal content excluding lithium satisfies the above range, effects of improving the resistance characteristics, capacity characteristics, and structural stability may be further maximized.

The Ni content based on the total metal content excluding lithium may be about 60 mol % or more, 65 mol % or more, 70 mol % or more, 70 mol % to 90 mol %, 70 mol % to 80 mol %, or 70 mol % to 75 mol %. When the above range is satisfied, the positive electrode active material may have excellent energy density and improved structural stability.

The average crystallite size may be about 500 nm to 800 nm, 520 nm to 780 nm, 550 nm to 750 nm, or 600 nm to 700 nm. When the above range is satisfied, the crystal structure of the positive electrode active material may be further stabilized, and the high-capacity characteristics may be achieved.

The positive electrode active material may have an I(003)/I(104) value measured by XRD, in a range of about 1.0 to 2.0, 1.0 to 1.5, 1.0 to 1.3, 1.0 to 1.2, 1.1 to 1.2, or 1.182 to 1.19. When the above range is satisfied, a layered structure of the positive electrode active material may be stably formed, and the crystallinity of the positive electrode active material may be secured to a certain level or higher. Accordingly, the cation mixing between lithium ions and nickel ions may be reduced, the structural stability may be excellent, the resistance may be reduced, and the cycle life characteristics may be excellent.

The positive electrode active material may have an average particle diameter D₅₀ of about 10.0 μm to 15.0 μm, 10.5 μm to 14.0 μm, 11.0 μm to 13.0 μm, or 11.2 μm to 12.0 μm. When the above range is satisfied, the crystal structure of the positive electrode active material may be stable, and side reactions with an electrolyte may be minimized.

The positive electrode active material may include secondary particles. In this case, the resistance, charge and discharge efficiency, and capacity characteristics may be excellent.

The positive electrode active material may include a calcined product of a mixture of the above-described precursor for a positive electrode active material and a lithium raw material. The positive electrode active material may be prepared by mixing the above-described precursor for a positive electrode active material and a lithium raw material and calcining the mixture. Since the method of preparing the positive electrode active material is the same as described below, a detailed description thereof will be omitted.

### Method of Preparing Positive Electrode Active Material

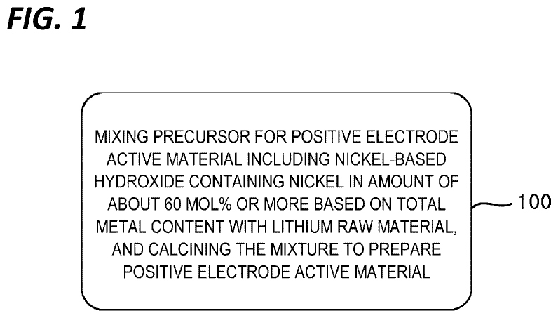

Referring to FIG. 1, the method of preparing a positive electrode active material, according to the present disclosure, includes mixing a precursor for a positive electrode active material including a nickel-based hydroxide containing nickel in an amount of about 60 mol % or more based on the total metal content with a lithium raw material, and calcinating the mixture to prepare a positive electrode active material (step 100).

The precursor for a positive electrode active material includes a nickel-based hydroxide containing nickel in an amount of about 60 mol % or more based on the total metal content. For example, the precursor for a positive electrode active material may include a nickel-based hydroxide containing nickel in an amount of about 60 mol % or more, 65 mol % or more, 70 mol % or more, less than 100 mol %, 95 mol % or less, 90 mol % or less, 85 mol % or less, 80 mol % or less, 75 mol % or less, 72 mol % or less, or 70 mol % or less, based on the total metal content. Alternatively, the precursor for a positive electrode active material may include a nickel-based hydroxide containing nickel in an amount of about 60 mol % or more, 65 mol % or more, 70 mol % or more, 70 mol % to 90 mol %, 70 mol % to 80 mol %, or 70 mol % to 75 mol %, based on the total metal content. Accordingly, the capacity characteristics of the positive electrode active material may be improved.

The precursor for a positive electrode active material has a ratio of a (101) crystallite size (unit: nm) to a Ni content (unit: mol %) in a range of about 1.5 nm/mol % to 2.0 nm/mol %, based on the total metal content. When a positive electrode active material is prepared using the precursor for a positive electrode active material, since the (101) crystallite size is controlled within a specific range before calcination, the positive electrode active material may be prepared such that a ratio of an average crystallite size to the nickel content satisfies a specific range even without relatively increasing a calcination temperature. Even in a positive electrode active material in which a nickel content based on the total metal content excluding lithium is 60 mol % or more, a rock-salt phase formed on the surface may be reduced, and the positive electrode active material may be prepared to be structurally stable.

Since the features of the precursor for a positive electrode active material are the same as those described above, detailed description thereof will be omitted.

The precursor for a positive electrode active material may be prepared according to the preparation method described below. When the precursor for a positive electrode active material is prepared according to the preparation method described below, the ratio of the (101) crystallite size (unit: nm) to the Ni content (unit: mol %) based on the total metal content may be controlled within a specific range. In the method of preparing the precursor for a positive electrode active material, factors such as a temperature of a reaction solution, a supply rate of a transition metal aqueous solution, and a pH of the reaction solution in a nucleation step, as well as a supply rate of the transition metal aqueous solution, a pH of the reaction solution, and a reaction time in a particle growth step significantly affect a growth rate and an internal structure of the precursor for a positive electrode active material. Therefore, these factors may act as major factors in controlling the ratio of the (101) crystallite size (unit: nm) to the Ni content (unit: mol %) based on the total metal content.

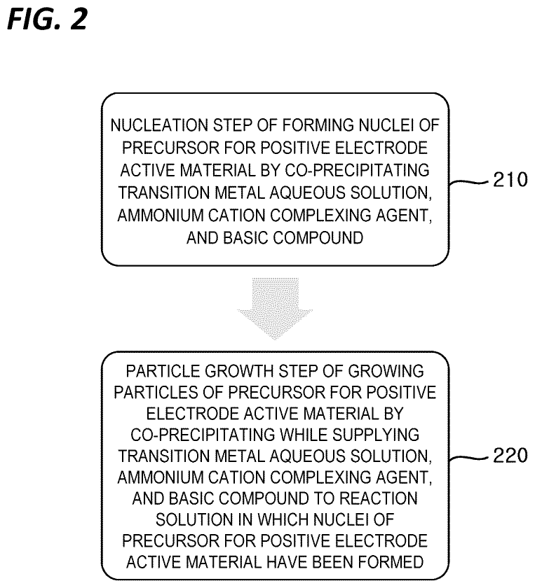

Referring to FIG. 2, the method of preparing the precursor for a positive electrode active material includes: (1) a nucleation step of forming nuclei of the precursor for a positive electrode active material by co-precipitating a transition metal aqueous solution, an ammonium cation complexing agent, and a basic compound (step 210); and (2) a particle growth step of growing particles of the precursor for a positive electrode active material by co-precipitating while supplying a transition metal aqueous solution, an ammonium cation complexing agent, and a basic compound to a reaction solution in which the nuclei of the precursor for a positive electrode active material have been formed (step 220).

### (Nucleation Step)

First, a reaction solution including nuclei of the precursor for a positive electrode active material may be formed by co-precipitating a transition metal aqueous solution, an ammonium cation complexing agent, and a basic compound. For example, the reaction solution including nuclei of the precursor for a positive electrode active material may be formed by co-precipitating while supplying a transition metal aqueous solution, an ammonium cation complexing agent, and a basic compound to a first reactor.

The first reactor may be a batch reactor. This is because, when a precursor is prepared using a continuous stirred-tank reactor (CSTR), it is difficult to control the particle size of precursor particles is difficult.

The first reactor may include a reaction mother liquor. For example, before supplying the transition metal aqueous solution, the ammonium cation complexing agent, and the basic compound as reaction raw materials, the ammonium cation complexing agent, the basic compound, and water may first be introduced into the first reactor to form the reaction mother liquor.

The ammonium cation complexing agent may be at least one selected from NH₄OH, (NH₄)₂SO₄, NH₄NO₃, NH₄Cl, CH₃COONH₄, and NH₄CO₃, and may be introduced into the reactor in the form of a solution obtained by dissolving the compound in a solvent. In this case, the solvent may be water or a mixture of water and an organic solvent (e.g., alcohol) that is uniformly miscible with water.

The basic compound may be at least one selected from NaOH, KOH, and Ca(OH)₂, and may be introduced into the reactor in the form of a solution obtained by dissolving the compound in a solvent. In this case, the solvent may be water or a mixture of water and an organic solvent (e.g., alcohol) that is uniformly miscible with water.

The reaction mother liquor may be formed to have a pH of about 9.5 to 12.0, 10.0 to 11.8, or from 10.0 to 11.5. When the pH of the reaction mother liquor satisfies the above range, the nucleation may proceed smoothly.

After introducing the ammonium cation complexing agent, the basic compound, and water into the first reactor to form the reaction mother liquor, oxygen in the reaction mother liquor may be removed by purging the first reactor with nitrogen gas.

Next, a transition metal aqueous solution, an ammonium cation complexing agent, and a basic compound are supplied to the first reactor, and a co-precipitation reaction is carried out while stirring to prepare a reaction solution in which precursor nuclei (seeds) are formed.

When the transition metal aqueous solution, the ammonium cation complexing agent, and the basic compound are supplied to the first reactor containing the reaction mother liquor and stirring is performed, a co-precipitation reaction proceeds such that precursor nuclei in the form of primary particles are formed, and the nuclei in the form of primary particles aggregate to form nuclei (seeds) in the form of secondary particles.

In the nucleation step, the transition metal aqueous solution may be supplied at a flow rate of about 0.1 L/h to 2 L/h, 0.2 L/h to 0.8 L/h, 0.3 L/h to 0.6 L/h, or 0.4 L/h to 0.5 L/h. The flow rate may be an average flow rate during the co-precipitation reaction. When the above range is satisfied, nuclei having an appropriate density gradient may be formed, thereby contributing to controlling the (101) crystallite size of the precursor for a positive electrode active material.

In the nucleation step, the ammonium cation complexing agent may be supplied at a flow rate of about 0.01 L/h to 1.50 L/h, 0.02 L/h to 1.20 L/h, 0.03 L/h to 1.00 L/h, or 0.05 L/h to 0.5 L/h. When the above range is satisfied, nuclei may be smoothly formed, a growth rate of the nuclei may be maintained, and sphericity may be improved.

In the nucleation step, the basic compound may be supplied at a flow rate of about 0.5 L/h to 2.5 L/h, 1.0 L/h to 2.0 L/h, or 1.2 L/h to 1.8 L/h. When the above range is satisfied, the pH of the reaction solution may be maintained within an appropriate range.

The transition metal aqueous solution may include nickel, cobalt, and an M¹ element (M¹ is manganese, aluminum, or a combination thereof), and may be formed by mixing a nickel raw material, a cobalt raw material, and an M¹ raw material in water.

The nickel raw material may be, for example, Ni(OH)₂, NiO, NiOOH, NiCO₃·2Ni(OH)₂·4H₂O, NiC₂O₄·2H₂O, Ni(NO₃)₂·6H₂O, NiSO₄, NiSO₄·6H₂O, nickel salt of fatty acid, or nickel halide, which may be used either alone or in a mixture of two or more thereof.

The cobalt raw material may be, for example, Co(OH)₂, CoOOH, Co(OCOCH₃)₂·4H₂O, Co(NO₃)₂·6H₂O, or CoSO₄·7H₂O, which may be used either alone or in a mixture of two or more thereof.

When M¹ is manganese, the manganese raw material may be manganese oxide such as Mn₂O₃, MnO₂, or Mn₃O₄; manganese salt such as MnCO₃, Mn(NO₃)₂, MnSO₄, manganese acetate, manganese salt of dicarboxylic acid, manganese citrate, or manganese salt of fatty acid; oxyhydroxide; or manganese chloride, which may be used either alone or in a mixture of two or more thereof.

When M¹ is aluminum, the aluminum raw material may be, for example, acetate, sulfate, sulfide, hydroxide, oxide, or oxyhydroxide containing aluminum, which may be used either alone or in a mixture of two or more thereof.

The transition metal aqueous solution may include a nickel raw material such that a nickel content is about 60 mol % or more, 65 mol % or more, 70 mol % or more, 70 mol % to 90 mol %, 70 mol % to 80 mol %, or 70 mol % to 75 mol %, based on the total moles of transition metals. When a nickel content in the transition metal aqueous solution is about 60 mol % or more, capacity characteristics may be further improved.

In the nucleation step, the content of transition metals included in the transition metal aqueous solution supplied thereto may be about 1.5 mol/L to 2.5 mol/L, or 1.8 mol/L to 2.3 mol/L.

When necessary, the transition metal aqueous solution may further include a doping element in addition to nickel, cobalt, and manganese. In this case, the doping element may include at least one selected from W, Cu, Fe, V, Cr, Ti, Zr, Zn, In, Ta, Y, Sr, Ga, Sc, Ca, Nb, Mg, B, and Mo. When the positive electrode active material further includes the doping element, for example, cycle life characteristics, discharge characteristics, and/or stability may be improved.

When the transition metal aqueous solution further includes the doping element, a raw material containing the doping element may be further added selectively during preparation of the transition metal aqueous solution.

As the raw material containing the doping element, at least one selected from acetate, sulfate, sulfide, hydroxide, oxide, or oxyhydroxide containing the doping element may be used.

The nucleation step may be performed for about 2 hours to 20 hours, 3 hours to 15 hours, or 4 hours to 10 hours. When the nucleation time is too short, nuclei may not be sufficiently generated, resulting in a reduced productivity and a non-uniform particle size distribution of precursor particles. In addition, when the nucleation time is too long, the reaction time required to grow the precursor particles to a desired particle size may become excessively long, thereby reducing productivity, and some particles may grow during the nucleation process, resulting in a non-uniform particle size distribution.

In addition, in the nucleation step, the pH of the reaction solution may be about 9.0 to 12.0, 9.2 to 11.0, 9.5 to 10.5, 9.7 to 10.3, or 9.9 to 10.1. When the above range is satisfied, the internal structure of nuclei of the precursor for the positive electrode active material is controlled, thereby contributing to controlling the (101) crystallite size of the precursor for the positive electrode active material. In addition, the nuclei of the precursor for the positive electrode active material may be formed in the reaction solution, and the nuclei may smoothly aggregate to form larger nuclei. The pH of the reaction solution may be controlled by adjusting the input amount of the basic compound using, for example, a pH sensor.

In the nucleation step, the temperature of the reaction solution may be about 40° C. to 80° C., 45° C. to 80° C., 50° C. to 78° C., 60° C. to 75° C., or 65° C. to 70° C. When the temperature of the reaction solution satisfies the above range, nucleation of the precursor for a positive electrode active material may proceed smoothly, and the internal structure of the nuclei of the precursor for a positive electrode active material may be controlled, thereby contributing to controlling the (101) crystallite size of the precursor for a positive electrode active material.

When nuclei of the precursor for a positive electrode active material are sufficiently formed in the nucleation step and the reaction is completed, the reaction solution may be transferred from the first reactor to a second reactor. When the reaction solution is transferred from the first reactor to the second reactor to perform a particle growth step described below, the flow rate of the transition metal aqueous solution may be easily controlled, and the particle growth rate of the precursor may be reduced. Accordingly, in the precursor for a positive electrode active material thus prepared, the ratio of a (101) crystallite size (unit: nm) to a Ni content (unit: mol %) based on the total metal content may be appropriately controlled.

### (Particle Growth Step)

When nuclei are sufficiently formed through the above-described process, particles of the precursor for a positive electrode active material may be grown by performing a co-precipitation reaction while supplying a transition metal aqueous solution, an ammonium cation complexing agent, and a basic compound to the reaction solution in which nuclei of the precursor for a positive electrode active material have been formed. For example, after transferring the reaction solution from the first reactor to the second reactor, the particles of the precursor for a positive electrode active material may be grown in the second reactor by performing a co-precipitation reaction while supplying a transition metal aqueous solution, an ammonium cation complexing agent, and a basic compound to the reaction solution in which the nuclei of the precursor for a positive electrode active material have been formed.

The supply rate of the ammonium cation complexing agent may be about 0.1 L/h to 0.5 L/h, 0.1 L/h to 0.3 L/h, or 0.1 L/h to 0.2 L/h. When the above range is satisfied, the crystal growth rate of the precursor may be controlled within an appropriate range, thereby contributing to preparing the precursor for a positive electrode active material in which the ratio of a (101) crystallite size (unit: nm) to a Ni content (unit: mol %) based on the total metal content satisfies a specific range.

The supply rate of the transition metal aqueous solution may be about 0.1 L/h to 2.0 L/h, 0.1 L/h to 1.5 L/h, 0.2 L/h to 1.2 L/h, 0.3 L/h to 1.0 L/h, or 0.5 L/h to 0.7 L/h. When the above range is satisfied, the crystal growth rate of the precursor may be controlled within an appropriate range, thereby contributing to preparing the precursor for a positive electrode active material in which the ratio of a (101) crystallite size (unit: nm) to a Ni content (unit: mol %) based on the total metal content satisfies a specific range.

The transition metal aqueous solution, the ammonium cation complexing agent, and the basic compound supplied in the particle growth step may be the same as those used in the nucleation step.

In the particle growth step, before supplying the transition metal aqueous solution, the ammonium cation complexing agent, and the basic compound to the reaction solution, dissolved oxygen may be removed by purging the reaction solution with an inert gas, for example, nitrogen (N₂) gas, thereby forming a non-oxidizing atmosphere in the reactor.

The inert gas may be supplied into the reactor for purging at a rate of about 100 L/h to 500 L/h, 200 L/h to 400 L/h, or 250 L/h to 350 L/h. When the above range is satisfied, the crystallinity of the precursor for a positive electrode active material may be improved.

The particle growth step may be performed in a nitrogen atmosphere. Accordingly, the crystallinity of the precursor may be appropriately controlled.

In the particle growth step, the pH at which the co-precipitation reaction occurs may be about 9.5 to 10.3, 9.7 to 10.27, 9.9 to 10.25, or 10.1 to 10.2. When the pH of the reaction solution satisfies the above range, the crystal growth rate of the precursor may be controlled within an appropriate range, thereby allowing preparation of a precursor for a positive electrode active material in which the ratio of a (101) crystallite size (unit: nm) to a Ni content (unit: mol %) based on the total metal content satisfies a specific range. The pH of the reaction solution may be controlled by adjusting the input amount of the basic compound using, for example, a pH sensor.

In the particle growth step, the stirring speed during the co-precipitation reaction may be about 200 rpm to 400 rpm, 220 rpm to 380 rpm, 250 rpm to 350 rpm, or 280 rpm to 320 rpm. When the above range is satisfied, the crystal growth rate of the precursor may be controlled within an appropriate range, thereby contributing to preparing a precursor for a positive electrode active material in which the ratio of a (101) crystallite size (unit: nm) to a Ni content (unit: mol %) based on the total metal content satisfies a specific range.

In the particle growth step, the co-precipitation reaction may be performed at a temperature of about 40° C. to 80° C., 45° C. to 80° C., or 45° C. to 75° C. When the reaction temperature satisfies the above range, particle growth may proceed smoothly.

In the particle growth step, the reaction for growing the particles of the precursor for a positive electrode active material may be performed for about 7 hours to 100 hours, 8 hours to 90 hours, 10 hours to 80 hours, 30 hours to 70 hours, 40 hours to 50 hours, or 43 hours to 46 hours. When the above range is satisfied, the particles of the precursor for a positive electrode active material may be grown to an appropriate size, and precursor particles in which the ratio of a (101) crystallite size (unit: nm) to a Ni content (unit: mol %) based on the total metal content is controlled within a desired range may be obtained.

When the precursor particles have sufficiently grown through the above process, the precursor particles may be separated from the reaction solution, washed, and then dried to obtain particles of the precursor for a positive electrode active material.

The drying may be performed at about 80° C. to 200° C., 100° C. to 180° C., or 120° C. to 160° C.

The drying may be performed for about 50 hours or less, 30 hours or less, or 10 hours to 15 hours or less.

The calcination may be performed by a calcination method known in the art, and the method is not particularly limited.

The lithium raw material may include, for example, lithium-containing carbonate (e.g., lithium carbonate), hydrate (e.g., lithium hydroxide hydrate (LiOH·H₂O)), hydroxide (e.g., lithium hydroxide), nitrate (e.g., lithium nitrate (LiNO₃)), or chloride (e.g., lithium chloride (LiCl)), which may be used either alone or in a mixture of two or more thereof.

The particles of the precursor for a positive electrode active material and the lithium raw material may be mixed by solid-state mixing such as jet milling. The mixing ratio of the particles of the precursor for a positive electrode active material and the lithium raw material may be determined within a range satisfying molar fractions of respective components in a positive electrode active material finally prepared. For example, the particles of the precursor for a positive electrode active material and the lithium raw material may be mixed such that the molar ratio of the particles of the precursor for a positive electrode active material to lithium element contained in the lithium raw material is about 1:1.0 to 1:1.5, or 1:1.0 to 1:1.3.

Although not essential, during the mixing, in addition to the particles of the precursor for a positive electrode active material and the lithium raw material, raw materials for doping a portion of transition metals and/or oxygen of the positive electrode active material may be further included. For example, during the mixing, the above-described raw materials containing the doping element may be additionally mixed.

The calcination may be performed at a temperature of about 600° C. to 900° C., 700° C. to 880° C., or 800° C. to 860° C. When calcined within the above temperature range, the calcination temperature may not be excessively high, thereby suppressing, for example, formation of a rock-salt phase on a surface of the positive electrode active material and oxygen release. In the method of preparing a positive electrode active material according to the present disclosure, the positive electrode active material is prepared by calcining a precursor for a positive electrode active material in which the ratio of a (101) crystallite size (unit: nm) to a Ni content (unit: mol %) based on total metal content is about 1.5 nm/mol % to 2.0 nm/mol %. Thus, even when calcination is performed within the above temperature range, a positive electrode active material having sufficient structural stability may be prepared.

The calcination may be performed for about 5 hours to 20 hours, 7 hours to 15 hours, or 8 hours to 12 hours. When calcination is performed within the above time range, calcination may be carried out within an appropriate time, the positive electrode active material may sufficiently grow, and a layered structure may be smoothly formed.

Since the positive electrode active material prepared accordingly is the same as described above, a detailed description thereof will be omitted.

### Positive Electrode

A positive electrode according to the present disclosure includes the positive electrode active material described above. For example, the positive electrode may include a positive electrode active material layer including the positive electrode active material described above, or may include a positive electrode current collector, and a positive electrode active material layer disposed on the positive electrode current collector and including the positive electrode active material described above.

Hereinafter, respective components of the positive electrode according to the present disclosure will be described.

### (1) Positive Electrode Current Collector

The positive electrode current collector may be any of various positive electrode current collectors used in the art. For example, the positive electrode current collector may include stainless steel, aluminum, nickel, titanium, calcined carbon, or aluminum or stainless steel surface-treated with, for example, carbon, nickel, titanium, or silver. The positive electrode current collector may generally have a thickness of about 3 μm to 500 μm, and fine irregularities may be formed on a surface of the positive electrode current collector to improve adhesion of the positive electrode active material. The positive electrode current collector may be used in various forms, such as a film, sheet, foil, net, porous body, foam, or nonwoven fabric.

### (2) Positive Electrode Active Material Layer

The positive electrode active material layer may be positioned on the positive electrode current collector and, for example, may be positioned on one surface or both surfaces of the positive electrode current collector. The positive electrode active material layer may have a single-layer structure or a multilayer structure including two or more layers.

The positive electrode active material layer may include a positive electrode active material, a positive electrode conductive agent, and a positive electrode binder.

Since the positive electrode active material is the same as the positive electrode active material according to the present disclosure described above, the characteristics of the positive electrode active material are the same as those described above.

The positive electrode active material may be included in an amount of about 90 wt % to 99 wt %, 92 wt % to 98 wt %, or 94 wt % to 98 wt %, based on the total weight of the positive electrode active material layer. When the above range is satisfied, the energy density and capacity characteristics of the lithium secondary battery to which the positive electrode is applied may be improved.

The positive electrode conductive agent is used to impart electrical conductivity to the electrode and may be used without particular limitation as long as it exhibits electronic conductivity without causing a chemical change in the battery. Examples of the positive electrode conductive agent may include: graphite such as natural graphite or artificial graphite; carbon-based materials such as carbon black, acetylene black, Ketjen black, channel black, furnace black, lamp black, thermal black, carbon fibers, or carbon nanotubes; metal powders or metal fibers of, for example, copper, nickel, aluminum, or silver; conductive whiskers of, for example, zinc oxide or potassium titanate; conductive metal oxides such as titanium oxide; or conductive polymers such as polyphenylene derivatives, which may be used either alone or in a mixture of two or more thereof. The positive electrode conductive agent may typically be included in an amount of about 0.1 wt % to 10 wt %, 0.5 wt % to 8 wt %, or 1 wt % to 4 wt %, based on the total weight of the positive electrode active material layer.

The positive electrode binder serves to enhance adhesion between particles of the positive electrode active material and between the positive electrode active material and the positive electrode current collector. Examples thereof may include: fluororesin-based binders such as polyvinylidene fluoride (PVDF) or polytetrafluoroethylene (PTFE); rubber-based binders such as styrene-butadiene rubber (SBR), acrylonitrile-butadiene rubber, or styrene-isoprene rubber; cellulose-based binders such as carboxymethyl cellulose (CMC), starch, hydroxypropyl cellulose, or regenerated cellulose; polyalcohol-based binders such as polyvinyl alcohol; polyolefin-based binders such as polyethylene or polypropylene; polyimide-based binders; polyester-based binders; and silane-based binders, which may be used either alone or in a mixture of two or more thereof. The positive electrode binder may be included in an amount of about 0.1 wt % to 10 wt %, 0.5 wt % to 10 wt %, or 1 wt % to 4 wt %, based on the total weight of the positive electrode active material layer.

The positive electrode may be prepared by a method known in the relevant technical field. For example, the positive electrode may be prepared by preparing a positive electrode slurry by mixing a positive electrode active material, a positive electrode binder, and a positive electrode conductive agent in a solvent, coating the positive electrode slurry onto a positive electrode current collector, and drying and rolling the coated layer. Alternatively, the positive electrode may be prepared by casting the positive electrode slurry onto a separate support, peeling off the resulting film from the support, and laminating the film obtained thereby onto the positive electrode current collector. As the solvent of the positive electrode slurry, solvents generally used for positive electrode slurries in the relevant technical field may be used. For example, dimethyl sulfoxide (DMSO), isopropyl alcohol, N-methyl-2-pyrrolidone (NMP), acetone, water, or a mixture thereof may be used, but the present disclosure is not limited thereto. The solvent may be used in an amount sufficient to dissolve or disperse the positive electrode active material, the positive electrode conductive agent, and the positive electrode binder, and to provide a viscosity suitable for uniform coating of the positive electrode slurry.

### Lithium Secondary Battery

A lithium secondary battery according to the present disclosure will be described. The lithium secondary battery according to the present disclosure includes the positive electrode according to the present disclosure, a negative electrode disposed to face the positive electrode, and an electrolyte. Optionally, the lithium secondary battery according to the present disclosure may further include a separator interposed between the positive electrode and the negative electrode.

Since the positive electrode is the same as described above, the remaining components other than the positive electrode will be described below.

### (1) Negative Electrode

In the lithium secondary battery according to the present disclosure, the negative electrode includes a negative electrode active material layer including a negative electrode active material. For example, the negative electrode may include a negative electrode current collector and a negative electrode active material layer disposed on at least one surface of the negative electrode current collector.

The negative electrode current collector is not particularly limited as long as it has high conductivity and does not cause chemical changes in the battery. For example, copper, stainless steel, aluminum, nickel, titanium, calcined carbon, a material in which the surface of copper or stainless steel is treated with, for example, carbon, nickel, titanium, or silver, or an aluminum-cadmium alloy may be used. In addition, the negative electrode current collector may typically have a thickness of about 3 μm to 500 μm. Similarly to the positive electrode current collector, fine irregularities may be formed on the surface of the current collector to enhance the adhesion strength of the negative electrode active material. For example, the negative electrode current collector may be used in various forms such as a film, a sheet, a foil, a net, a porous material, a foam, and a nonwoven fabric.

The negative electrode active material layer may be positioned on the negative electrode current collector. For example, the negative electrode active material layer may be positioned, on one surface or both surfaces of the negative electrode current collector. The negative electrode active material layer may have a single-layer structure or a multilayer structure including two or more layers.

When the negative electrode active material layer has a multilayer structure including two or more layers, the respective layers may differ from each other in the type and/or content of the negative electrode active material, negative electrode binder, and/or negative electrode conductive agent. By forming the negative electrode active material layer as a multilayer structure and making the compositions of respective layers differ from each other, the performance characteristics of the battery, such as rapid charging performance and output characteristics, may be appropriately adjusted.

As the negative electrode active material, a compound capable of reversibly intercalating and deintercalating lithium may be used. Examples thereof may include: carbon-based materials such as artificial graphite, natural graphite, graphitized carbon fiber, and amorphous carbon; metallic compounds capable of alloying with lithium, such as Si, Al, Sn, Pb, Zn, Bi, In, Mg, Ga, Cd, Si alloys, Sn alloys, or Al alloys; metal oxides capable of lithium doping and dedoping, such as SiO_{β} (0<β<2), SnO₂, vanadium oxides, and lithium vanadium oxides; or composites including the above-described metallic compounds and carbon-based materials, such as Si—C composites or Sn—C composites, which may be used either alone or in a mixture of two or more thereof.

The carbonaceous materials that may be used include both low-crystalline carbon and highly crystalline carbon. The low-crystallinity carbon may be soft carbon or hard carbon, and the high-crystallinity carbon may include high-temperature calcined carbon such as natural graphite or artificial graphite vin amorphous carbon, plate-shaped, flake-shaped, spherical, or fibrous forms, kish graphite, pyrolytic carbon, mesophase pitch-based carbon fibers, meso-carbon microbeads, mesophase pitches, and petroleum or coal tar pitch-derived cokes.

Alternatively, the negative electrode active material may be a carbon-based negative electrode active material. In this case, the carbon-based negative electrode active material may include, for example, natural graphite, artificial graphite, graphitized carbon fiber, amorphous carbon, soft carbon, hard carbon, or a combination thereof. Alternatively, the carbon-based negative electrode active material may include natural graphite and artificial graphite.

The carbon-based negative electrode active material may have an average particle diameter D₅₀ of about 2 μm to 30 μm, or 5 μm to 30 μm.

The negative electrode active material may be included in an amount of about 80 wt % to 98 wt %, 90 wt % to 98 wt %, or 93 wt % to 98 wt %, based on the total weight of the negative electrode active material layer. When the content of the negative electrode active material satisfies the above range, excellent energy density may be achieved.

The negative electrode active material layer may further include a negative electrode conductive agent and/or a negative electrode binder together with the negative electrode active material.

The negative electrode conductive agent is used to impart electrical conductivity to the negative electrode and may be used without particular limitation as long as the negative electrode conductive agent exhibits electronic conductivity without causing a chemical change in the battery. Examples thereof may include: carbon-based materials such as carbon black, acetylene black, Ketjen black, channel black, furnace black, lamp black, thermal black, carbon fibers, and carbon nanotubes; metal powders or metal fibers of copper, nickel, aluminum, or silver; conductive whiskers of, for example, zinc oxide or potassium titanate; conductive metal oxides such as titanium oxide; and conductive polymers such as polyphenylene derivatives, which may be used either alone or in a mixture of two or more thereof.

The negative electrode conductive agent may typically be included in an amount of about 0.1 wt % to 10 wt %, 0.1 wt % to 8 wt %, or 0.1 wt % to 5 wt %, based on the total weight of the negative electrode active material layer.

The negative electrode binder serves to enhance adhesion between negative electrode active material particles and between the negative electrode active material and the negative electrode current collector. Examples of the negative electrode binder may include: polyvinylidene fluoride (PVDF); vinylidene fluoride-hexafluoropropylene copolymer (PVDF-co-HFP); polyvinyl alcohol; polyacrylonitrile; carboxymethyl cellulose (CMC); starch; hydroxypropyl cellulose; regenerated cellulose; polyvinylpyrrolidone; polytetrafluoroethylene; polyethylene; polypropylene; ethylene-propylene-diene monomer rubber (EPDM rubber); sulfonated EPDM; styrene-butadiene rubber (SBR); fluoro rubber; or various copolymers thereof, which may be used either alone or in a mixture of two or more thereof.

The negative electrode binder may be included in an amount of about 0.1 wt % to 10 wt %, 0.5 wt % to 10 wt %, or 1 wt % to 8 wt % based on the total weight of the negative electrode active material layer.

The negative electrode may be prepared by a method known in the relevant technical field. For example, the negative electrode may be prepared by preparing a negative electrode slurry by mixing a negative electrode active material, a negative electrode binder, and a negative electrode conductive agent in a solvent, coating the negative electrode slurry onto a negative electrode current collector, and drying and rolling the coated layer. Alternatively, the negative electrode may be prepared by casting the negative electrode slurry onto a separate support, peeling off the resulting film from the support, and laminating the film obtained thereby onto the negative electrode current collector.

Meanwhile, as the solvent for the negative electrode slurry, solvents generally used in the relevant technical field may be used. For example, dimethyl sulfoxide (DMSO), isopropyl alcohol, N-methyl-2-pyrrolidone (NMP), acetone, water, or a mixture thereof may be used, but the present disclosure is not limited thereto. The solvent may be used in an amount sufficient to dissolve or disperse the negative electrode active material, the negative electrode conductive agent, and the negative electrode binder, and to provide a viscosity suitable for uniform coating of the negative electrode slurry.

### (2) Electrolyte

The electrolyte according to the present disclosure may include a lithium salt and an organic solvent.

The lithium salt may be used without particular limitation as long as it is a compound capable of providing lithium ions used in a lithium secondary battery. For example, as the lithium salt, LiPF₆, LiClO₄, LiAsF₆, LiBF₄, LiSbF₆, LiAlO₄, LiAlCl₄, LiCF₃SO₃, LiCAF₉SO₃, LiN(C₂F₅SO₃)₂, LiN(C₂F₅SO₂)₂, LiN(CF₃SO₂)₂, LiCl, LiI, or LiB(C₂O₄)₂ may be used. The concentration of the lithium salt is preferably in a range of about 0.1 M to 5.0 M, or 0.1 M to 3.0 M. When the concentration of the lithium salt is within the above range, the electrolyte has appropriate conductivity and viscosity, and thus may exhibit excellent electrolyte performance, and lithium ions may effectively migrate.

The organic solvent may include at least one selected from a cyclic carbonate-based organic solvent, a linear carbonate-based organic solvent, a linear ester-based organic solvent, and a cyclic ester-based organic solvent.

The cyclic carbonate-based organic solvent is a high-viscosity organic solvent having a high dielectric constant and capable of effectively dissociating the lithium salt in the electrolyte, and may be, for example, a non-fluorinated saturated cyclic carbonate-based organic solvent. The cyclic carbonate-based organic solvent may include at least one organic solvent selected from ethylene carbonate (EC), fluoroethylene carbonate (FEC), propylene carbonate (PC), 1,2-butylene carbonate, 2,3-butylene carbonate, 1,2-pentylene carbonate, 2,3-pentylene carbonate, and vinylene carbonate. For example, the cyclic carbonate-based organic solvent may include at least one selected from ethylene carbonate (EC) and fluoroethylene carbonate (FEC), or may include ethylene carbonate (EC).

In addition, the linear carbonate-based organic solvent is an organic solvent having low viscosity and a low dielectric constant and may be, for example, a non-fluorinated linear carbonate. The linear carbonate-based organic solvent may include at least one selected from dimethyl carbonate (DMC), diethyl carbonate (DEC), dipropyl carbonate, ethyl methyl carbonate (EMC), methyl propyl carbonate, and ethyl propyl carbonate. Alternatively, the linear carbonate-based organic solvent may include at least one selected from ethyl methyl carbonate (EMC) and diethyl carbonate (DEC), or may include ethyl methyl carbonate (EMC).

The linear ester-based organic solvent may include, for example, at least one organic solvent selected from methyl acetate, ethyl acetate, propyl acetate, methyl propionate, ethyl propionate, propyl propionate, and butyl propionate.

The cyclic ester-based organic solvent may include at least one organic solvent selected from butyrolactone, valerolactone, and caprolactone.

Alternatively, the electrolyte according to the present disclosure may include ethylene carbonate and dimethyl carbonate as the organic solvent.

Meanwhile, the electrolyte may further include other additives in addition to the above-described electrolyte components for the purposes of improving cycle life characteristics of a battery, suppressing capacity reduction, and enhancing discharge capacity.

For example, the additive may include at least one selected from non-fluorinated unsaturated cyclic carbonate-based compounds, halogen-substituted carbonate-based compounds, sultone-based compounds, sulfate-based compounds, borate-based compounds, nitrile-based compounds, benzene-based compounds, amine-based compounds, silane-based compounds, and lithium salt-based compounds different from the lithium salt included in the electrolyte.

For example, the additive may include one or more compounds selected from vinylene carbonate (VC), vinyl ethylene carbonate, fluoroethylene carbonate (FEC), 1,3-propane sultone (PS), 1,4-butane sultone, ethenesultone, 1,3-propene sultone (PRS), 1,4-butene sultone, 1-methyl-1,3-propene sultone, ethylene sulfate (ESA), trimethylene sulfate (TMS), methyl trimethylene sulfate (MTMS), tetraphenylborate, lithium oxalyldifluoroborate, succinonitrile, adiponitrile, acetonitrile, propionitrile, butyronitrile, valeronitrile, caprylonitrile, heptanenitrile, cyclopentanecarbonitrile, cyclohexanecarbonitrile, 2-fluorobenzonitrile, 4-fluorobenzonitrile, difluorobenzonitrile, trifluorobenzonitrile, phenylacetonitrile, 2-fluorophenylacetonitrile, 4-fluorophenylacetonitrile, fluorobenzene, triethanolamine, ethylenediamine, tetravinylsilane, LiN(SO₂F)₂ (lithium bis(fluorosulfonyl)imide, LiFSI), LiN(SO₂CF₃)₂ (lithium bis(trifluoromethanesulfonyl)imide, LiTFSI), LiPO₂F₂, LiODFB, LiBOB (lithium bis(oxalato)borate, LiB(C₂O₄)₂), and LiBF₄.

These additives may be included in an amount of about 0.01 wt % to 20 wt %, or 0.05 wt % to 5.0 wt %, based on the total weight of the electrolyte. When the above range is satisfied, low-temperature output characteristics, high-temperature storage characteristics, and high-temperature life characteristics of the battery may be improved, side reactions in the electrolyte may be reduced, and the presence of unreacted additives may be suppressed.

### (3) Separator

The separator physically separates a negative electrode and a positive electrode and provides a path for lithium-ion migration, and any separator commonly used in lithium secondary batteries may be used without particular limitation. In this case, the separator may be interposed between the positive electrode and the negative electrode.

As the separator, a porous polymer film made of a polyolefin-based polymer, such as an ethylene homopolymer, a propylene homopolymer, an ethylene/butene copolymer, an ethylene/hexene copolymer, or an ethylene/methacrylate copolymer, or a laminated structure including two or more layers thereof, may be used. In addition, conventional porous nonwoven fabrics such as nonwoven fabrics made of, for example, high-melting-point glass fibers or polyethylene terephthalate fibers may be used. In addition, a coated separator including a ceramic component or a polymer material to ensure heat resistance or mechanical strength may be used, and may optionally be used in a single-layer or multilayer structure.

The lithium secondary battery according to the present disclosure may be advantageously applied to portable devices such as mobile phones, laptop computers, and digital cameras, as well as to electric vehicle fields such as hybrid electric vehicles (HEVs). The lithium secondary battery according to the present disclosure may have excellent thermal stability and may exhibit excellent capacity characteristics, and thus may be advantageously used in the electric vehicle field.

According to another embodiment of the present disclosure, a battery module including the lithium secondary battery according to the present disclosure as a unit cell and a battery pack including the same are provided.

The battery module or the battery pack may be used as a power source for one or more medium- or large-sized devices such as power tools, electric vehicles (EVs) including hybrid electric vehicles (HEVs) and plug-in hybrid electric vehicles (PHEVs), or energy storage systems.

Hereinafter, the present disclosure will be described with reference to examples. However, the following examples are provided only to enable those skilled in the art to fully understand and easily implement the present disclosure, and the scope of the present disclosure is not limited to the following examples.

### Preparation Example

### Preparation Example 1

### (1) Nucleation Step

NiSO₄, CoSO₄, and MnSO₄ were dissolved in ion-exchanged water in amounts such that a molar ratio of nickel: cobalt: manganese was 7:1:2, thereby preparing a transition metal aqueous solution having a concentration of 2.0 M. A 10 L batch reactor (first reactor) was charged with distilled water, aqueous ammonia having a concentration of 9 wt %, and an aqueous sodium hydroxide solution having a concentration of 25 wt %. While purging the first reactor with N₂ gas and stirring at 300 rpm, the temperature of the first reactor was increased.

When the temperature of the solution inside the first reactor reached 70° C., the transition metal aqueous solution was continuously introduced at a supply rate of 0.4 L/h and an aqueous ammonia solution having a concentration of 20 wt % was introduced at a supply rate of 0.1 L/h, and the sodium hydroxide aqueous solution was introduced using a pH-linked pump to maintain the pH of the reaction solution at 10.0. In the nucleation step, the reaction was carried out for about 5 hours such that the average particle diameter D₅₀ of the prepared nuclei became about 4.5 μm. The reaction solution in which the nuclei were formed was transferred from the first reactor to a second reactor.

### (2) Particle Growth Step

Next, in the second reactor, the transition metal aqueous solution was supplied to the reaction solution in which the nuclei of the precursor for a positive electrode active material had been formed, while maintaining a supply rate of 0.7 L/h for the transition metal aqueous solution and 0.1 L/h for the aqueous ammonia having a concentration of 9 wt %. An aqueous sodium hydroxide solution was introduced using a pH-linked pump to maintain the pH of the reaction solution at 10.2, and the co-precipitation reaction was carried out at 300 rpm. When the average particle diameter D₅₀ of the particles of the precursor for a positive electrode active material reached 12.3 μm, the reaction was terminated, and the total reaction time was 45 hours.

After separating the precursor particles from the reaction solution, impurities were removed through washing, and the particles were dried in a drying oven at a temperature of 140° C. for 12 hours and then sieved to prepare a precursor for a positive electrode active material.

### Preparation Example 2

### (1) Nucleation Step

NiSO₄, CoSO₄, and MnSO₄ were dissolved in ion-exchanged water in amounts such that a molar ratio of nickel: cobalt: manganese was 7:1:2, thereby preparing a transition metal aqueous solution having a concentration of 2.0 M. A 10 L batch reactor (first reactor) was charged with distilled water, aqueous ammonia having a concentration of 9 wt %, and an aqueous sodium hydroxide solution having a concentration of 25 wt %. While purging with N₂ gas and stirring at 300 rpm, the temperature of the first reactor was increased.

When the temperature of the solution inside the first reactor reached 65° C., the transition metal aqueous solution was continuously introduced at a supply rate of 0.4 L/h and an aqueous ammonia solution having a concentration of 20 wt % was introduced at a supply rate of 0.1 L/h, and the sodium hydroxide aqueous solution was introduced using a pH-linked pump to maintain the pH of the reaction solution at 10.0. In the nucleation step, the reaction was carried out for about 5 hours such that the average particle diameter D₅₀ of the prepared nuclei became about 4.5 μm. The reaction solution in which the nuclei were formed was transferred from the first reactor to a second reactor.

### (2) Particle Growth Step

Next, in the second reactor, the transition metal aqueous solution was supplied to the reaction solution in which the nuclei of the precursor for a positive electrode active material had been formed, while maintaining a supply rate of 0.7 L/h for the transition metal aqueous solution and 0.1 L/h for the aqueous ammonia having a concentration of 9 wt %. An aqueous sodium hydroxide solution was introduced using a pH-linked pump to maintain the pH of the reaction solution at 10.2, and the co-precipitation reaction was carried out at 300 rpm. When the average particle diameter D₅₀ of the particles of the precursor for a positive electrode active material reached 12.3 μm, the reaction was terminated, and the total reaction time was 44 hours.

After separating the precursor particles from the reaction solution, impurities were removed through washing, and the particles were dried in a drying oven at a temperature of 140° C. for 12 hours and then sieved to prepare a precursor for a positive electrode active material.

### Preparation Example 3

### (1) Nucleation Step

NiSO₄, CoSO₄, and MnSO₄ were dissolved in ion-exchanged water in amounts such that a molar ratio of nickel: cobalt: manganese was 7:1:2, thereby preparing a transition metal aqueous solution having a concentration of 2.0 M. A 10 L batch reactor (first reactor) was charged with distilled water, aqueous ammonia having a concentration of 9 wt %, and an aqueous sodium hydroxide solution having a concentration of 25 wt %. While purging with N₂ gas and stirring at 300 rpm, the temperature of the first reactor was increased.

When the temperature of the solution inside the reactor reached 65° C., the transition metal aqueous solution was continuously introduced at a supply rate of 0.4 L/h and an aqueous ammonia solution having a concentration of 20 wt % was introduced at a supply rate of 0.1 L/h, and the sodium hydroxide aqueous solution was introduced using a pH-linked pump to maintain the pH of the reaction solution at 10.4. In the nucleation step, the reaction was carried out for about 5 hours such that the average particle diameter D₅₀ of the prepared nuclei became about 4.5 μm. The reaction solution in which the nuclei were formed was transferred from the first reactor to a second reactor.

### (2) Particle Growth Step

Next, in the second reactor, the transition metal aqueous solution was supplied to the reaction solution in which the nuclei of the precursor for a positive electrode active material had been formed, while maintaining a supply rate of 0.7 L/h for the transition metal aqueous solution and 0.1 L/h for the aqueous ammonia having a concentration of 9 wt %. An aqueous sodium hydroxide solution was introduced using a pH-linked pump to maintain the pH of the reaction solution at 10.6, and the co-precipitation reaction was carried out at 300 rpm. When the average particle diameter D₅₀ of the particles of the precursor for a positive electrode active material reached 12.4 μm, the reaction was terminated, and the total reaction time was 47 hours.

After separating the precursor particles from the reaction solution, impurities were removed through washing, and the particles were dried in a drying oven at a temperature of 140° C. for 12 hours and then sieved to prepare a precursor for a positive electrode active material.

### Preparation Example 4

### (1) Nucleation Step

NiSO₄, CoSO₄, and MnSO₄ were dissolved in ion-exchanged water in amounts such that a molar ratio of nickel: cobalt: manganese was 7:1:2, thereby preparing a transition metal aqueous solution having a concentration of 2.0 M. A 10 L batch reactor (first reactor) was charged with distilled water, aqueous ammonia having a concentration of 9 wt %, and an aqueous sodium hydroxide solution having a concentration of 25 wt %. While purging with N₂ gas and stirring at 300 rpm, the temperature of the first reactor was increased.

When the temperature of the solution inside the first reactor reached 70° C., the transition metal aqueous solution was continuously introduced at a supply rate of 0.4 L/h and an aqueous ammonia solution having a concentration of 20 wt % was introduced at a supply rate of 0.1 L/h, and the sodium hydroxide aqueous solution was introduced using a pH-linked pump to maintain the pH of the reaction solution at 10.2. In the nucleation step, the reaction was carried out for about 5 hours such that the average particle diameter D₅₀ of the prepared nuclei became about 4.5 μm. The reaction solution in which the nuclei were formed was transferred from the first reactor to a second reactor.

### (2) Particle Growth Step

Next, in the second reactor, the transition metal aqueous solution was supplied to the reaction solution in which the nuclei of the precursor for a positive electrode active material had been formed, while maintaining a supply rate of 0.7 L/h for the transition metal aqueous solution and 0.1 L/h for the aqueous ammonia having a concentration of 9 wt %. An aqueous sodium hydroxide solution was introduced using a pH-linked pump to maintain the pH of the reaction solution at 10.4, and the co-precipitation reaction was carried out at 300 rpm. When the average particle diameter D₅₀ of the particles of the precursor for a positive electrode active material reached 12.0 μm, the reaction was terminated, and the total reaction time was 48 hours.

After separating the precursor particles from the reaction solution, impurities were removed through washing, and the particles were dried in a drying oven at a temperature of 140° C. for 12 hours and then sieved to prepare a precursor for a positive electrode active material.

### Preparation Example 5

### (1) Nucleation Step

NiSO₄, CoSO₄, and MnSO₄ were dissolved in ion-exchanged water in amounts such that a molar ratio of nickel: cobalt: manganese was 7:1:2, thereby preparing a transition metal aqueous solution having a concentration of 2.0 M. A 10 L batch reactor (first reactor) was charged with distilled water, aqueous ammonia having a concentration of 9 wt %, and an aqueous sodium hydroxide solution having a concentration of 25 wt %. While purging with N₂ gas and stirring at 300 rpm, the temperature of the first reactor was increased.

When the temperature of the solution inside the first reactor reached 60° C., the transition metal aqueous solution was continuously introduced at a supply rate of 0.4 L/h and an aqueous ammonia solution having a concentration of 20 wt % was introduced at a supply rate of 0.1 L/h, and the sodium hydroxide aqueous solution was introduced using a pH-linked pump to maintain the pH of the reaction solution at 10.0. In the nucleation step, the reaction was carried out for about 5 hours such that the average particle diameter D₅₀ of the prepared nuclei became about 4.5 μm. The reaction solution in which the nuclei were formed was transferred from the first reactor to a second reactor.

### (2) Particle Growth Step

Next, in the second reactor, the transition metal aqueous solution was supplied to the reaction solution in which the nuclei of the precursor for a positive electrode active material had been formed, while maintaining a supply rate of 0.7 L/h for the transition metal aqueous solution and 0.1 L/h for the aqueous ammonia having a concentration of 9 wt %. An aqueous sodium hydroxide solution was introduced using a pH-linked pump to maintain the pH of the reaction solution at 10.2, and the co-precipitation reaction was carried out at 300 rpm. When the average particle diameter D₅₀ of the particles of the precursor for a positive electrode active material reached 12.0 μm, the reaction was terminated, and the total reaction time was 41 hours.

After separating the precursor particles from the reaction solution, impurities were removed through washing, and the particles were dried in a drying oven at a temperature of 140° C. for 12 hours and then sieved to prepare a precursor for a positive electrode active material.

### Preparation Example 6

### (1) Nucleation Step

NiSO₄, CoSO₄, and MnSO₄ were dissolved in ion-exchanged water in amounts such that a molar ratio of nickel: cobalt: manganese was 7:1:2, thereby preparing a transition metal aqueous solution having a concentration of 2.0 M. A 10 L batch reactor (first reactor) was charged with distilled water, aqueous ammonia having a concentration of 9 wt %, and an aqueous sodium hydroxide solution having a concentration of 25 wt %. While purging with N₂ gas and stirring at 300 rpm, the temperature of the first reactor was increased.

When the temperature of the solution inside the first reactor reached 65° C., the transition metal aqueous solution was continuously introduced at a supply rate of 0.5 L/h and an aqueous ammonia solution having a concentration of 20 wt % was introduced at a supply rate of 0.1 L/h, and the sodium hydroxide aqueous solution was introduced using a pH-linked pump to maintain the pH of the reaction solution at 9.8. In the nucleation step, the reaction was carried out for about 5 hours such that the average particle diameter D₅₀ of the prepared nuclei became about 4.5 μm. The reaction solution in which the nuclei were formed was transferred from the first reactor to a second reactor.

### (2) Particle Growth Step

Next, in the second reactor, the transition metal aqueous solution was supplied to the reaction solution in which the nuclei of the precursor for a positive electrode active material had been formed, while maintaining a supply rate of 0.8 L/h for the transition metal aqueous solution and 0.1 L/h for the aqueous ammonia having a concentration of 9 wt %. An aqueous sodium hydroxide solution was introduced using a pH-linked pump to maintain the pH of the reaction solution at 9.6, and the co-precipitation reaction was carried out at 300 rpm. When the average particle diameter D₅₀ of the particles of the precursor for a positive electrode active material reached 12.3 μm, the reaction was terminated, and the total reaction time was 23 hours.

After separating the precursor particles from the reaction solution, impurities were removed through washing, and the particles were dried in a drying oven at a temperature of 140° C. for 12 hours and then sieved to prepare a precursor for a positive electrode active material.

### Experimental Example 1: X-Ray Diffraction Analysis and Characterization of Precursor for Positive Electrode Active Material

X-ray diffraction analysis was performed on the precursor for a positive electrode active material prepared in each of Preparation Examples 1 to 6 to evaluate the ratio of the (101) crystallite size (unit: nm) to a Ni content (unit: mol %) and I(001)/I(100) based on the total metal content. In addition, D₅₀, SPAN value, and pore area ratio (PAR) were measured by the following methods. The results are shown in Table 1 below.

### (1) Ratio of (101) Crystallite Size (Unit: Nm) to Ni Content (Unit: Mol %) Based on Total Metal Content

Samples of the precursors for a positive electrode active material prepared in Preparation Examples 1 to 6 were placed in a recessed center groove of a holder for general powder samples. The surface of each sample was leveled using a slide glass while adjusting the height to be flush with an edge of the holder, and X-ray diffraction (XRD) analysis was performed using an X-ray diffractometer (Bruker, D₈ Endeavor) under the following measurement conditions. The obtained XRD data were analyzed using the Fundamental Parameter Approach built into the TOPAS program of Brucker, based on the Rietveld method, to obtain a (101) crystallite size (unit: nm). Using the obtained data, the ratio of the (101) crystallite size (unit: nm) to a Ni content (unit: mol %) based on the total metal content was calculated.
Measurement conditions: radiation source: Cu Kα, λ=1.54 Å, 2θ=10°-80°, step size=0.02°, total scan time: 120 min

### (2) I(001)/I(100)

From the XRD data obtained when measuring the ratio of the (101) crystallite size (unit: nm) to a Ni content (unit: mol %) based on the total metal content, the I(001)/I(100) value may be measured by fitting all peaks within the measurement range using the FP (First Principle) peak type available in TOPAS while applying only the Lorentzian contribution. At this time, strain was not considered.

### (3) D₅₀

The precursors for a positive electrode active material prepared in Preparation Examples 1 to 6 were collected, and the particle size distribution was measured on a volume basis using a particle size distribution analyzer (Microtrac S3500, Microtrac). Specifically, 0.03 g of the precursor sample for a positive electrode active material was dispersed in a dispersing medium, introduced into the particle size distribution analyzer (Microtrac S3500, Microtrac), and irradiated with ultrasonic waves at about 28 kHz with an output of 60 W to obtain a cumulative volume particle size distribution graph. The particle diameter at a cumulative volume of 50% was determined from the cumulative volume particle size distribution graph.

TABLE 1

| | (101) Crystallite | | |
|---|---|---|---|
| | size/Ni content | | |
| | based on total | | |
| | metal content | | |
| | [nm/mol %] | I(001)/I(100) | D₅₀ [μm] |
| Preparation Example 1 | 1.80 | 3.4 | 12.3 |
| Preparation Example 2 | 1.91 | 3.5 | 12.3 |
| Preparation Example 3 | 2.88 | 4.5 | 12.4 |
| Preparation Example 4 | 1.4 | 4.2 | 12.0 |
| Preparation Example 5 | 2.1 | 3.7 | 12.0 |
| Preparation Example 6 | 2.1 | 3.6 | 12.3 |

### Examples and Comparative Examples

### Example 1

The precursor for a positive electrode active material prepared in Preparation Example 1 and LiOH were mixed such that the molar ratio of (Ni+Co+Mn): Li was 1:1.05, and the mixture was calcined at 840° C. for 10 hours to prepare a positive electrode active material. The prepared positive electrode active material had a composition of LiNi_{0.7}Co_{0.1}Mn_{0.2}O₂, an average particle diameter D₅₀ of 12 μm, and was confirmed to have a secondary particle form.

### Example 2

A positive electrode active material was prepared in the same manner as in Example 1, except that the precursor for a positive electrode active material prepared in Preparation Example 2 was used. The prepared positive electrode active material had a composition of LiNi_{0.7}Co_{0.1}Mn_{0.2}O₂ and was confirmed to have a secondary particle form.

### Comparative Example 1

A positive electrode active material was prepared in the same manner as in Example 1, except that the precursor for a positive electrode active material prepared in Preparation Example 3 was used. The prepared positive electrode active material had a composition of LiNi_{0.7}Co_{0.1}Mn_{0.2}O₂ and was confirmed to have a secondary particle form.

### Comparative Example 2

A positive electrode active material was prepared in the same manner as in Example 1, except that the precursor for a positive electrode active material prepared in Preparation Example 4 was used. The prepared positive electrode active material had a composition of LiNi_{0.7}Co_{0.1}Mn_{0.2}O₂ and was confirmed to have a secondary particle form.

### Comparative Example 3

A positive electrode active material was prepared in the same manner as in Example 1, except that the precursor for a positive electrode active material prepared in Preparation Example 5 was used. The prepared positive electrode active material had a composition of LiNi_{0.7}Co_{0.1}Mn_{0.2}O₂ and was confirmed to have a secondary particle form.

### Comparative Example 4

A positive electrode active material was prepared in the same manner as in Example 1, except that the precursor for a positive electrode active material prepared in Preparation Example 6 was used. The prepared positive electrode active material had a composition of LiNi_{0.7}Co_{0.1}Mn_{0.2}O₂ and was confirmed to have a secondary particle form.

### Experimental Example 2: X-Ray Diffraction Analysis and Characterization of Positive Electrode Active Material

X-ray diffraction analysis was performed on the positive electrode active materials prepared in Examples 1 to 2 and Comparative Examples 1 to 4 to measure the ratio (unit: nm/mol %) of the average crystallite size (unit: nm) to the Ni content (unit: mol %) among the total metals excluding lithium, and the I(003)/I(104) value. The results are shown in Table 2 below.

### (1) Ratio of Average Crystallite Size (Unit: Nm) to Ni Content (Unit: Mol %) Based on Total Metal Content Excluding Lithium

Samples of the positive electrode active materials prepared in Examples 1 to 2 and Comparative Examples 1 to 4 were placed in a recessed groove at the center of a general powder holder. The surface of each sample was leveled using a slide glass while adjusting the height to be flush with the edge of the holder, and X-ray diffraction (XRD) analysis was performed under the following measurement conditions using an X-ray diffractometer (Bruker, D₈ Endeavor). The obtained XRD data were analyzed using the Fundamental Parameter Approach embedded in the TOPAS program of Bruker, based on the Rietveld method, to obtain an average crystallite size (unit: nm). Using the obtained data, the ratio of the average crystallite size (unit: nm) to the Ni content (unit: mol %) based on the total metal content excluding lithium was calculated.
Measurement conditions: radiation source: Cu Kα, λ=1.54 Å, 2θ=10° to 80°, step size=0.02°, total scan time: 120 min

### (2) I(003)/I(104)

From the XRD data obtained when measuring the ratio of the average crystallite size (unit: nm) to the Ni content (unit: mol %) based on the total metal content excluding lithium, the I(003)/I(104) value may be measured by fitting all peaks within the measurement range using the FP (First Principle) peak type available in TOPAS while applying only the Lorentzian contribution. At this time, strain was not considered.

### (3) D₅₀

The positive electrode active materials prepared in Examples 1 to 2 and Comparative Examples 1 to 4 were collected, and the particle size distribution was measured on a volume basis using a particle size distribution analyzer (Microtrac S3500, Microtrac). Specifically, 0.03 g of the positive electrode active material sample was dispersed in a dispersing medium, introduced into the particle size distribution analyzer (Microtrac S3500, Microtrac), and irradiated with ultrasonic waves at about 28 kHz with an output of 60 W to obtain a cumulative volume particle size distribution graph. The particle diameter at a cumulative volume of 50% was determined from the cumulative volume particle size distribution graph.

TABLE 2

| | Ratio of average crystallite size | | |
|---|---|---|---|
| | to Ni content based on total | | |
| | metal content excluding lithium | | |
| | [unit: nm/mol %] | I(003)/I(104) | D₅₀ [μm] |
| Example 1 | 2.97 | 1.1856 | 11.50 |
| Example 2 | 2.91 | 1.1821 | 11.43 |
| Comparative | 6.43 | 1.2206 | 11.52 |
| Example 1 | | | |
| Comparative | 1.8 | 1.1810 | 11.45 |
| Example 2 | | | |
| Comparative | 3.03 | 1.1804 | 11.8 |
| Example 3 | | | |
| Comparative | 3.3 | 1.1711 | 11.62 |
| Example 4 | | | |

### Experimental Example 3: Cycle Life Characteristics Evaluation

The positive electrode active material prepared in each of Examples 1 to 2 and Comparative Examples 1 to 4, carbon black as a conductive agent, and PVdF as a binder were mixed in N-methyl-2-pyrrolidone at a weight ratio of 95.0:2.5:2.5 to prepare a positive electrode slurry. The positive electrode slurry was coated on one surface of an aluminum foil, dried at 130° C., and then roll-pressed to prepare a positive electrode.

For the negative electrode, artificial graphite, carbon black as a conductive agent, and a styrene-butadiene rubber (SBR)-carboxymethyl cellulose (CMC) composite as a binder were mixed at a weight ratio of 95.5:1.0:3.5 to prepare a negative electrode slurry. The slurry was coated on one surface of a copper current collector, dried at 100° C., and then roll-pressed to prepare a negative electrode.

A separator was interposed between the positive electrode and the negative electrode prepared as described above to manufacture an electrode assembly, and the electrode assembly was positioned inside a battery case. An electrolyte was then injected into the case to manufacture a lithium secondary battery. In this case, the electrolyte was prepared by dissolving 1.0 M lithium hexafluorophosphate (LiPF₆) in an organic solvent obtained by mixing ethylene carbonate (EC) and ethyl methyl carbonate (EMC) at a volume ratio of 1:2.

The lithium secondary batteries to which the positive electrode active materials of Examples 1 to 2 and Comparative Examples 1 to 4 prepared as described above were applied were each charged to 4.45 V at 0.5 C under constant current at 45° C. and then discharged to 2.5 V at 1.0 C under constant current, and this process was defined as one cycle. Charge-discharge cycling was performed for 50 cycles.

### (1) Capacity Retention Rate

The capacity retention rate was calculated using the following equation, and the results are shown in Table 4 below.

$$Capacity retention rate ( \% ) = \{ ( discharge capacity after 50 cycles / discharge capacity after 1 cycle ) \} \times 100$$

### (2) Resistance Increase Rate

After one charge-discharge cycle, the discharge capacity after 1 cycle was measured using an electrochemical charge-discharge tester, the SOC was adjusted to 0%, and then a pulse of 0.1 C was applied for 60 seconds. The initial resistance was calculated from the difference between the voltage before pulse application and the voltage after application.

After 50 charge-discharge cycles, the resistance after 50 cycles was calculated in the same manner, and the resistance increase rate was calculated using the following equation. The results are shown in Table 3 below.

$$Resistance increase rate ( \% ) = ( resistance after 50 cycles - initial resistance ) / initial resistance \times 100$$

TABLE 3

| | Capacity retention | Resistance increase |
|---|---|---|
| | rate [%] | rate [%] |
| Example 1 | 95.2 | 63.5 |
| Example 2 | 94.5 | 78.1 |
| Comparative Example 1 | 89.1 | 115.2 |
| Comparative Example 2 | 89.2 | 118.1 |
| Comparative Example 3 | 88.5 | 101.2 |
| Comparative Example 4 | 92.4 | 120.4 |

Referring to Table 3, it may be seen that the lithium secondary batteries to which the positive electrode active materials of Examples 1 and 2, prepared using the precursors for a positive electrode active material prepared in Preparation Examples 1 and 2, were applied exhibit a higher capacity retention rate and a lower resistance increase rate than the lithium secondary batteries to which the positive electrode active materials of Comparative Examples 1 to 4, prepared using the precursors for a positive electrode active material prepared in Preparation Examples 3 to 6, were applied. Referring collectively to Tables 1 to 3, it may be seen that, unlike the precursors for a positive electrode active material used in the preparation of the positive electrode active materials of Comparative Examples 1 to 4, the precursors for a positive electrode active material used in the preparation of the positive electrode active materials of Examples 1 to 2 fall within a range of 1.5 nm/mol % to 2.0 nm/mol % in terms of the ratio of the (101) crystallite size to the Ni content based on the total metal content. In addition, it may be seen that, unlike the positive electrode active materials of Comparative Examples 1 to 4, the positive electrode active materials of Examples 1 to 2 fall within a range of 1.9 nm/mol % to 3.0 nm/mol % in terms of the ratio of the average crystallite size to the Ni content based on the total metal content excluding lithium.

While the technology of the present disclosure has been described with reference to embodiments, it may be appreciated by one skilled in the art of the present disclosure or one having ordinary skill in the art of the present disclosure that various modifications and changes may be made to the various embodiments of the present disclosure without departing from the technical scope of the various embodiments of the present disclosure defined in the claims attached herewith. Therefore, the technical scope of the various embodiments of the present disclosure is not limited to the detailed descriptions of the invention herein, but should be determined by the scope defined in the claims.

What is claimed is:

1. A precursor for a positive electrode active material, the precursor comprising:
a nickel-based hydroxide containing nickel in an amount of about 60 mol % or more, based on total metal content,
wherein a ratio of a (101) crystallite size (unit: nm) to a Ni content (unit: mol %) is about 1.5 nm/mol % to 2.0 nm/mol %, based on the total metal content.

2. The precursor for a positive electrode active material according to claim 1,
wherein the nickel-based hydroxide is represented by Formula 1: 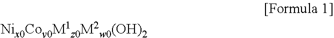
wherein, 0.60≤x0<1.0, 0<y0≤0.3, 0<20≤0.3, and 0≤w0≤0.1,M¹ is Mn, Al, or a combination thereof, and M² is one or more doping elements selected from W, Cu, Fe, V, Cr, Ti, Zr, Zn, In, Ta, Y, Sr, Ga, Sc, Ca, Nb, Mg, B, and Mo.

3. The precursor for a positive electrode active material according to claim 1, wherein an average particle diameter D₅₀ is about 10.0 μm to 15.0 μm.

4. The precursor for a positive electrode active material according to claim 1, wherein the nickel content based on the total metal content is about 70 mol % to 80 mol %.

5. The precursor for a positive electrode active material according to claim 1, wherein the (101) crystallite size is about 100 nm to 200 nm.

6. The precursor for a positive electrode active material according to claim 1, wherein an I(001)/I(100) value measured by XRD is about 3.0 to 4.0.

7. A positive electrode active material comprising:
a lithium nickel-based oxide containing nickel in an amount of about 60 mol % or more based on total metal content excluding lithium,
wherein a ratio of an average crystallite size (unit: nm) to a Ni content (unit: mol %) is about 1.9 nm/mol % to 3.0 nm/mol %, based on the total metal content excluding lithium.

8. The positive electrode active material according to claim 7, wherein the positive electrode active material includes secondary particles.

9. The positive electrode active material according to claim 7, wherein an average particle diameter D₅₀ is about 10.0 μm to 15.0 μm.

10. The positive electrode active material according to claim 7, wherein the average crystallite size is about 500 nm to 800 nm.

11. The positive electrode active material according to claim 7, wherein an I(003)/I(104) value measured by XRD is about 1.0 to 2.0.

12. A positive electrode comprising the positive electrode active material according to claim 7.

13. A lithium secondary battery comprising:
the positive electrode according to claim 12;
a negative electrode disposed to face the positive electrode; and
an electrolyte.

14. A method of preparing a positive electrode active material, the method comprising:
mixing a precursor for a positive electrode active material including a nickel-based hydroxide containing nickel in an amount of about 60 mol % or more based on total metal content with a lithium raw material, and calcining the mixture to prepare a positive electrode active material,
wherein the precursor for a positive electrode active material has a ratio of a (101) crystallite size (unit: nm) to a Ni content (unit: mol %) of about 1.5 nm/mol % to 2.0 nm/mol %, based on the total metal content.

15. The method according to claim 14, wherein the calcining is performed at a temperature of about 600° C. to 900° C.

16. The method according to claim 14, wherein the precursor for a positive electrode active material is prepared through:
(1) forming nuclei of the precursor for a positive electrode active material by co-precipitating a transition metal aqueous solution, an ammonium cation complexing agent, and a basic compound to form a reaction solution; and
(2) growing particles of the precursor for a positive electrode active material by co-precipitating while supplying a transition metal aqueous solution, an ammonium cation complexing agent, and a basic compound to the reaction solution in which the nuclei of the precursor for a positive electrode active material have been formed.

17. The method according to claim 16, wherein (1) is performed in a first reactor, and (2) is performed after transferring the reaction solution in which the nuclei of the precursor for a positive electrode active material have been formed, from the first reactor to a second reactor.
